(19) United States
(12) Patent Application Publication
(10) Pub. No.: US 2026/0240069 A1
(43) Pub. Date: Aug. 20, 2026

(54) AUTOMATED ADJUSTMENT OF CROP DEVELOPMENT ESTIMATES

(71) Applicant: PIONEER HI-BRED INTERNATIONAL, INC., JOHNSTON, IA (US)

(72) Inventors: KARL BRAUER, RANSOM CANYON, TX (US); RAMESH BUYYARAPU, WAUKEE, IA (US); NATHAN DAVID COLES, JOHNSTON, IA (US); JAKE WRYNE COTTRELL, PLAINVIEW, TX (US); STUART GARDNER, DES MOINES, IA (US); DANIEL PRESTON GORMAN, TALLAHASSEE, FL (US); JULIEN LINARES, CARLSBAD, CA (US); MUSTAFA MCPHERSON, LELAND, MS (US); OLUSEYI SAMUEL ODUBOTE, ANKENY, IA (US); CHAITANYAM POTNURU, SRIKAKULAM (IN); TARA LUANA BARRETT TARNOWSKI, DES MOINES, IA (US); SARA TIRADO TOLOSA, HAMILTON (CA)

(73) Assignee: PIONEER HI-BRED INTERNATIONAL, INC., JOHNSTON, IA (US)

(21) Appl. No.: 19/160,950

(22) PCT Filed: Mar. 1, 2024
(86) PCT No.: PCT/US2024/018083

§ 371 Date: Aug. 29, 2025

Related U.S. Application Data
(60) Provisional application No. 63/488,009, filed on Mar. 2, 2023.

(51) Int. Cl. A01C 7/08; A01B 79/00; A01B 79/02; A01G 25/16; D01B 1/04; G06T 7/00; G06V 10/82; G06V 20/10; G06V 20/17

(52) U.S. Cl. CPC A01C 7/08; A01B 79/005; A01B 79/02; A01G 25/167; D01B 1/04; G06T 7/0014; G06V 10/82; G06V 20/17; G06V 20/188; G06T 2207/10032; G06T 2207/20081; G06T 2207/20084; G06T 2207/30188

(57) ABSTRACT

Systems, methods, and apparatuses for generating crop development estimates are described. A mechanized harvester may acquire ground-based samples associated with a trait of a crop variety from sample locations. An image capture device may acquire images associated with a trait of the crop variety in the sample locations. Ground-based estimates and raw estimates may be generated using the acquired images and machine learning models, and the differences determined between the raw estimates and ground-based estimates. A predictive analysis of the raw estimates and the ground-based estimates may be used to determine a correction factor. Images of the crop variety in a second location that is not included in the sample locations may be acquired and used to generate additional raw estimates. And a corrected estimate may be generated based on fitting the correction factor to the additional raw estimates.

### FIELD OF USE

Aspects of the disclosure relate generally to automatically adjusting crop development estimates that may be used to generate planting instructions for a crop. More specifically, aspects of the disclosure provide for the automatic intake and processing of images of crop locations to generate crop development estimates that may be used to generate planting instructions that may be implemented by a planting device.

### BACKGROUND

Generating a development estimate (e.g., a yield estimate) for a crop can be a time consuming process and involve a significant amount of analysis and calculation. In some cases, estimating crop yield may require samples to be manually gathered from the sites at which crops were planted. The samples for one site may be used to estimate yield at that site based on the conditions that existed at the time the samples were gathered. However, the estimated yield for one sample site may not be applicable to another site that may have different growth conditions (e.g., different altitude, weather, and/or temperature). Further, the accuracy of an estimated yield for a same sample site may vary based on the time of year at which samples were gathered. As a result, the estimated yield for a site at one time of the year may not be accurate with respect to a sample gathered from the same site at a different time of the year. Accordingly, there may be room for improvement in the way that various types of development estimates of crops are determined.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may allow for automatic methods, systems, non-transitory machine-readable media, and/or devices for the automated generation and adjustment of crop development estimates. More particularly, some aspects described herein may provide a system for generating a yield estimate for a cotton crop variety of a single genotype. The system may comprise a mechanized cotton harvester that is configured to extract seed cotton from cotton bolls of a cotton crop variety in a plurality of sample locations. The cotton crop variety may be of a single genotype. The system may further comprise a cotton gin that is configured to separate cotton lint from the seed cotton in the plurality of sample locations. The cotton gin may be further configured to gather ground-based lint samples of the cotton crop variety based on the cotton lint extracted in the plurality of sample locations. The system may comprise an aerial device comprising an image capture device that is configured to acquire first image data comprising images of the cotton crop variety in the plurality of sample locations. The aerial device may be further configured to acquire second image data comprising images of the cotton crop variety in a second location that is not included in the plurality of sample locations. The system may comprise a computing device that is configured to generate, based on the second image data, an image-based yield estimate for the cotton crop variety in the second location. The computing device may be further configured to generate, based on fitting a correction factor to the image-based yield estimate, a corrected yield estimate for the cotton crop variety of the single genotype at the second location. The computing device may be further configured to generate, based on the image-based yield estimate, cotton planting instructions associated with cultivation of the cotton crop variety. The system may further comprise a mechanical cotton planter that is configured to receive the cotton planting instructions and plant seeds in the second location based on the planting instructions.

According to some aspects described herein, the system may further comprise a sprinkler irrigation system configured to receive the planting instructions, and irrigate the cotton crop variety in the second location using quantities of water based on the cotton planting instructions.

According to some aspects described herein, the planting instructions may comprise instructions associated with a distribution of the cotton crop variety that is planted at locations comprising the plurality of sample locations and the second location.

According to some aspects described herein, the computing device may comprise one or more processors and a memory storing instructions that, when executed by the one or more processors, cause the computing device to generate the yield estimate for the cotton crop variety at the second location by performing operations comprising: determining, based on analysis of the ground-based lint samples, a plurality of ground-based yield estimates; determining, based on inputting the first image data into one or more machine learning models, a plurality of image-based yield estimates corresponding to the plurality of sample locations; determining, for each of the plurality of sample locations, differences between the plurality of image-based yield estimates and the plurality of ground-based yield estimates; determining, based on a predictive analytic model of the plurality of image-based yield estimates and the plurality of ground-based yield estimates, the correction factor, wherein the predictive analytic model comprises minimization of the differences between the plurality of raw yield estimates and the plurality of ground-based yield estimates in each of the plurality of sample locations; and determining, based on inputting the second image data into the one or more machine learning models the second raw yield estimate.

Some aspects described herein may provide a method of generating a crop development estimate for a crop variety. The method may comprise: acquiring, by a mechanized harvester, ground-based samples associated with at least one trait of a crop variety in a plurality of sample locations; acquiring, by an image capture device, first image data comprising images associated with the at least one trait of the crop variety in the plurality of sample locations; generating, by a computing device, based on the ground-based samples of the crop variety, a plurality of ground-based estimates associated with the at least one trait of the crop variety in the plurality of sample locations; generating, by the computing device comprising one or more processors, based on inputting the first image data into one or more machine learning models, a plurality of first raw estimates corresponding to the plurality of sample locations; determining, by the computing device, for each of the plurality of sample locations, differences between the plurality of first raw estimates and the plurality of ground-based estimates; determining, by the computing device, based on predictive analysis of the plurality of first raw estimates and the plurality of ground-based estimates, a correction factor associated with minimization of the differences between the plurality of first raw estimates and the plurality of ground-based estimates in each of the plurality of sample locations; acquiring, by the image capture device, second image data comprising images of the crop variety in a second location that is not included in the plurality of sample locations; generating, by the computing device, based on inputting the second image data into the one or more machine learning models, a second raw estimate; and generating, by the computing device, based on fitting the correction factor to the second raw estimate, a corrected estimate for the crop variety in the second location.

According to some aspects described herein, the crop variety may comprise a single genotype of cotton. Further, the plurality of first raw estimates and the plurality of ground-based estimates may be based on lint yields of the single genotype of cotton or a boll compactness of the single genotype of cotton. Furthermore, the plurality of sample locations and the second location may be within growing environments that comprise one or more environmental conditions that are within a predetermined range of similarity. The one or more environmental conditions may comprise annual rainfall, average annual temperature, and/or soil moisture.

According to some aspects described herein, the crop variety may comprise a single genotype of corn, and wherein the plurality of first raw estimates and the plurality of ground-based estimates may be based on a number of bushels per acre of the single genotype of corn.

According to some aspects described herein, the image capture device may comprise an aircraft comprising an aerial drone. Further, the image capture device may be configured to generate first image data by capturing the images from above the plurality of sample locations.

According to some aspects described herein, the method may comprise acquiring, by the image capture device, third image data comprising a second set of images of the crop variety in one of the plurality of sample locations. The second set of images may be captured at a different time interval from a time interval at which the images of the crop variety in the plurality of sample locations were captured. The method may further comprise generating, by the computing device, based on inputting the third image data into the one or more machine learning models, a third raw estimate; and generating, by the computing device, based on fitting the correction factor to the third raw estimate, a corrected estimate for the crop variety at the different time interval.

According to some aspects described herein, the predictive analysis may employ a predictive analytic model that may comprise linear regression analysis, and the plurality of sample locations and the crop variety may be independent variables in the linear regression analysis. Further, the plurality of first raw estimates may be dependent variables in the linear regression analysis.

According to some aspects described herein, the method may comprise determining, by the computing device, a mean raw estimate based on the plurality of first raw estimates of the plurality of sample locations; and determining, by the computing device, that the predictive analysis is based on at least a predetermined number of the plurality of first raw estimates that are greater than the mean raw estimate and a predetermined number of the plurality of first raw estimates that are less than the mean raw estimate.

According to some aspects described herein, the one or more machine learning models may comprise a first machine learning model configured to extract one or more features from the images of the crop variety in the plurality of sample locations.

According to some aspects described herein, the one or more machine learning models may comprise a second machine learning model configured to generate the plurality of first raw estimates based on the one or more features extracted by the first machine learning model. Further, the one or more machine learning models may comprise a convolutional neural network and the one or more features may comprise crop cover or crop area.

According to some aspects described herein, the at least one trait of the crop may comprise a yield trait, a phenological trait, an agronomic trait, a plant quality trait, a biotic stress trait, and/or an abiotic stress trait.

According to some aspects described herein, the one or more machine learning models may comprise a linear model.

According to some aspects described herein, the images of the crop variety in the plurality of sample locations and the images of the crop variety in the second location may have been captured within the same time interval.

According to some aspects described herein, the plurality of sample locations and the second location may be within a predetermined geographic area.

According to some aspects described herein, the predictive analysis may comprise linear regression analysis, nonlinear regression analysis, or machine learning model based analysis.

Some aspects described herein may provide one or more non-transitory computer readable media comprising instructions that, when executed by at least one processor, cause a computing device to perform operations. The operations may comprise receiving ground-based samples associated with at least one trait of a crop variety in a plurality of sample locations that were acquired by a mechanized harvester; receiving first image data acquired by an image capture device, wherein the first image data comprises images associated with the at least one trait of the crop variety in the plurality of sample locations; generating, based on the ground-based samples associated with at the least one trait of the crop variety, a plurality of ground-based estimates associated with the at least one trait of the crop variety in the plurality of sample locations; generating, based on inputting the first image data into one or more machine learning models, a plurality of first raw estimates corresponding to the plurality of sample locations; determining, for each of the plurality of sample locations, differences between the plurality of first raw estimates and the plurality of ground-based estimates; determining, based on a predictive analysis of the plurality of first raw estimates and the plurality of ground-based estimates, a correction factor associated with minimization of differences between the plurality of first raw estimates and the plurality of ground-based estimates in each of the plurality of sample locations; receiving, from the image capture device, second image data comprising images of the crop variety in a second location that is not included in the plurality of sample locations; generating, based on inputting the second image data into the one or more machine learning models, a second raw estimate; and generating, based on fitting the correction factor to the second raw estimate, a corrected estimate for the crop variety in the second location.

According to some aspects described herein, the predictive analysis may comprise linear regression analysis, nonlinear regression analysis, or machine-learning model based analysis.

Corresponding apparatuses, devices, systems, and computer-readable media (e.g., non-transitory computer readable media) are also within the scope of the disclosure. By more accurately estimating crop yield, the benefits of optimized planting may be achieved.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an example of a computing system that may be used to implement one or more aspects of the disclosure.

FIG. 2 shows an example of a system comprising one or more machine learning models according to one or more aspects of the disclosure.

FIG. 3 shows an example of predictive analysis and the generation of a correction factor for crop yield estimates according to one or more aspects of the disclosure.

FIG. 4 shows an example of predictive analysis and the generation of a correction factor for estimates associated with phenological traits of a crop according to one or more aspects of the disclosure.

FIG. 5 shows an example of predictive analysis and generating a correction factor for estimates associated with agronomic traits of a crop according to one or more aspects of the disclosure.

FIG. 6 shows an example of predictive analysis and generating a correction factor for estimates associated with plant quality traits of a crop according to one or more aspects of the disclosure.

FIG. 7 shows an example of predictive analysis and generating a correction factor for estimates associated with biotic stress traits or abiotic stress traits of a crop according to one or more aspects of the disclosure.

FIG. 8 shows a timing diagram that indicates a data flow of signals associated with generating and sending planting instructions in accordance with aspects of the present disclosure.

FIG. 9 shows an example flow chart for automated generation of crop development estimates according to one or more aspects of the disclosure.

FIG. 10 shows an example flow chart for implementing planting instructions according to one or more aspects of the disclosure.

FIG. 11 shows an example flow chart for generating corrected crop development estimates according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized, and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

Aspects described herein are generally directed to improving the effectiveness with which crop development estimates may be generated. The process of generating crop development estimates (e.g., crop yield estimates) may be labor intensive, require large amounts of data, and involve a degree of manual review and analysis. Even after spending time and resources to analyze data, the resulting crop development estimates may not be accurate. Further, the generation of highly accurate ground-based estimates based on manually gathering ground-based samples may consume significantly more resources (e.g., energy, expense, and/or labor) and time in comparison to what are often less accurate estimates based on processing images (e.g., images captured by image capture devices of an aircraft) of a sample location. Through novel implementations of sophisticated image processing techniques and the generation of a correction factor based on use of the processed images, more accurate crop development estimates may be achieved as described herein.

In particular, the disclosed technology may leverage the use of machine-learning models, to generate raw estimates associated with a crop trait (e.g., yield, disease resistance, and/or drought response) that impacts crop development. The raw estimates from a variety of sample locations may be compared to ground-based estimates from the same sample locations. The ground-based estimates may represent a ground-truth estimate and may be based on samples that were gathered using a collection device such as a harvester. Differences between the raw estimates and the ground-based estimates may be analyzed and a correction factor may be generated through the use of various techniques including linear regression analysis. The correction factor may adjust a raw estimate so that it is more similar to a corresponding ground-based estimate. The correction factor may then be applied to raw estimates at sample locations that are different from the initial set of sample locations and from which ground-based samples were not collected and ground-based estimates were not generated.

According to the aspects described herein, a variety of technical effects and benefits may be achieved by automatically generating a correction factor based on the intake and processing of image data. These novel techniques may result in an improvement in the accuracy with which crop development estimates may be generated while also using fewer resources to achieve the crop development estimates. As a result, the implementation of the disclosed technology may provide for highly accurate crop development estimates with a reduction in the overall costs, energy, and manual intervention used to generate the crop development estimates. By way of introduction, aspects discussed herein may relate to systems, devices, methods, and non-transitory computer readable media for generating crop development estimates.

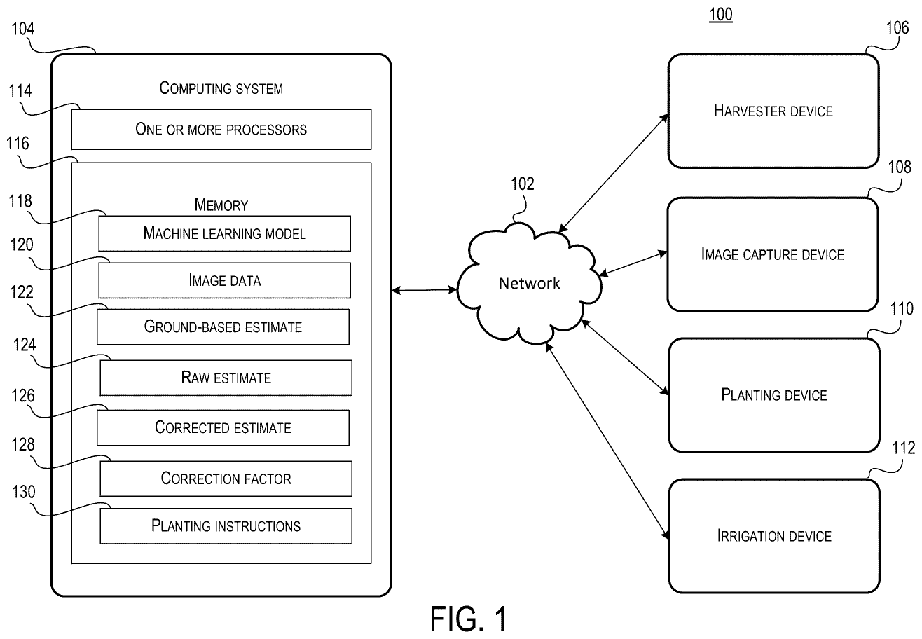

Before discussing these concepts in greater detail, however, several examples of computing devices and/or computing systems that may be used in implementing and/or otherwise providing various aspects of the disclosure will first be discussed with respect to FIG. 1.

FIG. 1 shows an example of a system that may be used to implement one or more aspects of the disclosure. In particular, FIG. 1 depicts a diagram of a computing system that may be configured to perform operations comprising the exchange and processing of signals and/or data that may be used to generate a corrected yield estimate and/or planting instructions for use in crop cultivation. As shown in FIG. 1, system 100 includes the network 102, a computing system 104, a harvester device 106, an image capture device 108, a planting device 110, and/or an irrigation device 112. Computing system 104 may comprise one or more processors 114, memory 116, one or more machine learning models 118, image data 120, ground-based estimate 122, correction factor 128, and/or a planting instructions 130. System 100 may operate in a standalone environment and/or as part of a networked environment that may include other devices and/or systems. For example, system 100 may operate in conjunction with other computing systems and/or other computing devices not shown in FIG. 1. As shown in FIG. 1, various computing devices including computing system 104, harvester device 106, image capture device 108, planting device 110, and/or irrigation device 112 may be interconnected via the network 102. Further, system 100 may operate via one or more networks not including the network 102 shown in FIG. 1.

Network 102 may be used to communicate (e.g., send and/or receive) signals, information, and/or data. For example, network 102 may be used to communicate image data 120 that may be sent from image capture device 108 to computing system 104. Network 102 may include any combination of wired and/or wireless networks and may carry any type of signal or communication including communications and/or signals using one or more communication protocols (e.g., TCP/IP, HTTP, and/or HTTPS). Further, network 102 may include any combination of a local area network (LAN), an intranet, a wide area network (WAN), and/or the Internet. Furthermore, network 102 may be configured or arranged according to any known topology and/or architecture.

Computing system 104 may, in some embodiments, implement one or more aspects of the present disclosure by accessing and/or executing instructions; and/or performing one or more operations based at least in part on the instructions. For example, computing system 104 may generate instructions (e.g., planting instructions 130) that may be used by the planting device 110. In some embodiments, the computing system 104 may be incorporated into and/or include a computing device (e.g., a computing device with one or more processors, one or more memory devices, one or more input devices, and/or one or more output devices). For example, computing system 104 may be incorporated into and/or include a desktop computer, a computer server, a computer client, a mobile device (e.g., a laptop computer, a tablet computer, a smart phone, and/or a smart watch), and/or any other type of processing device.

Computing system 104 may include one or more interconnects for communication between different components of the computing device. Computing system 104 may also include a network interface via which computing system 104 may exchange one or more signals including information and/or data with other computing systems and/or computing devices. For example, computing system 104 may send information and/or data (e.g., the planting instructions 130) to a planting device 110 via the network 102. By way of further example, computing system 104 may receive information and/or data, via the network 102, from harvester device 106 and/or image capture device 108 and may acknowledge that the information and/or data was received. Further, computing system 104 may include one or more input devices (e.g., a keyboard, mouse, touch screen, stylus, and/or microphone) and/or one or more output devices (e.g., a display device and/or audio output devices including loudspeakers).

Computing system 104 may include one or more computing devices. Further, as seen in FIG. 1, computing system 104 may include one or more processors 114 and a memory 116. The one or more processors 114 may include any combination of processing devices (e.g., one or more computer processing units (CPUs), one or more graphics processing units (GPUs), one or more processor cores, one or more microprocessors, one or more application specific integrated circuits (ASICs), one or more field programmable gate arrays (FPGAs), and/or one or more controllers). By way of example, computing system 104 may comprise the one or more processors 114 and memory 116 that may store instructions that, when executed by the one or more processors 114, causes computing system 104 to perform operations which may include the operations described herein. The one or more processors 114 may execute instructions including instructions stored in the memory 116. Further, the one or more processors 114 may be arranged in various configurations including any combination of one or more serial processors and/or one or more parallel processors.

The memory 116 may include one or more computer-readable media (e.g., non-transitory computer-readable media) and may be configured to store data and/or instructions including one or more machine learning models 118 and/or image data 120. Further, the memory 116 may include one or more memory devices including random access memory (RAM), read only memory (ROM), programmable read only memory (PROM), erasable programmable read only memory (EPROM), electrically erasable programmable read only memory (EEPROM), solid state drives (SSDs), hard disk drives (HDDs), and/or hybrid memory devices that use a combination of different types of memory technologies.

As shown in FIG. 1, the memory may be used to store data which may comprise one or more machine learning models 118, image data 120, ground-based estimate 122, and/or correction factor 128. One or more machine learning models 118 may include instructions that may be used perform operations based on data comprising image data 120, ground-based estimate 122, and/or correction factor 128. As described herein, one or more machine learning models 118 may be configured to generate one or more raw estimates associated with at least one trait of a crop variety based on image data 120, ground-based estimate 122, and/or correction factor 128, associated with a crop. Further, one or more machine learning models 118 may be configured to generate output comprising planting instructions 130, which may be used by planting device 110 to irrigate crops based on information (e.g., an amount of water to apply to crops) indicated in planting instructions 130. The computing system 104 may send any portion of memory 116 to other devices and/or make any portion of memory 116 accessible to other devices. For example, computing system 104 may send planting instructions 130 to planting device 110 and/or irrigation device 112.

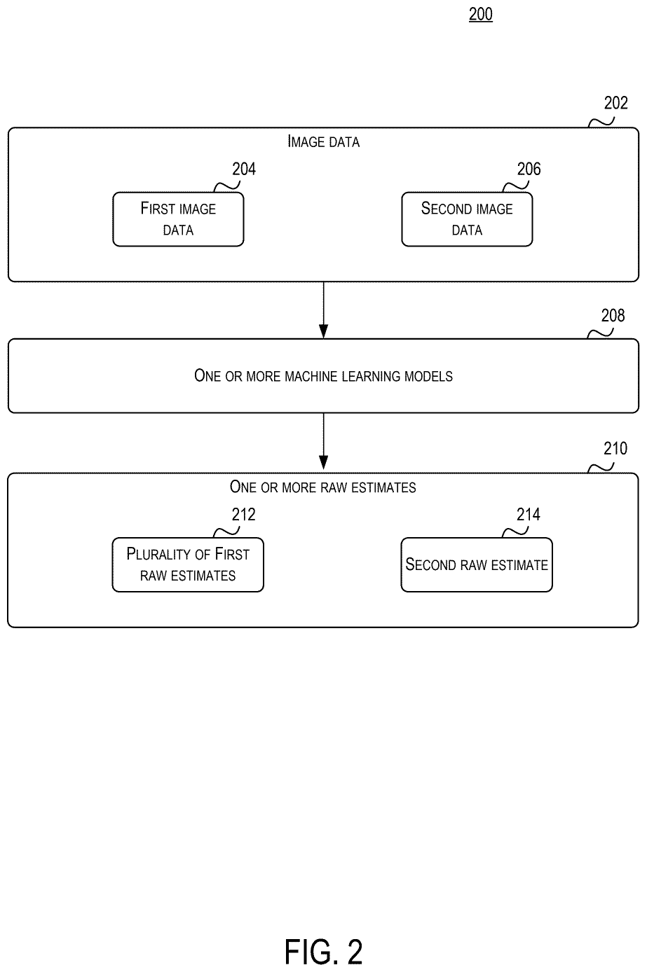

Image data 120 may include information associated with samples of soil that were acquired and/or analyzed by harvester device 106. Further, image data 120 may comprise information indicating the state of soil in a region in which a crop may be grown and may be used in the generation of one or more raw estimates associated with at least one trait of a crop variety and/or planting instructions 130 as described herein. Image data 120 may include the information and/or features of image data 202 described herein with respect to FIG. 2.

Ground-based estimate 122 may comprise an estimated yield of a crop based on samples of a crop variety that were acquired from a plurality of sample locations. For example, a ground-based estimated yield for a corn crop may comprise an estimate of a number of bushels of corn per acre (e.g., one hundred and seventy bushels per acre) for corn in a sample location. Ground-based estimate 122 may comprise a plurality of ground-based estimates associated with at least one trait of a crop variety in a plurality of locations. For example, ground-based estimate 122 may comprise four yield estimates for wheat at four different sample locations. Ground-based estimate 122 may be based on information acquired by harvester device 106. Further, ground-based estimate 122 may be used in the generation of a correction factor as described herein.

Raw estimate 124 may comprise an estimated yield of a crop based on samples of a crop variety that were acquired from a plurality of sample locations. For example, a ground-based estimated yield for a corn crop may comprise an estimate of a number of bushels of corn per acre (e.g., one hundred and seventy bushels per acre) for corn in a sample location. Raw estimate 124 may comprise a plurality of ground-based estimates associated with at least one trait of a crop variety in a plurality of locations. For example, raw estimate 124 may comprise four yield estimates for wheat at four different sample locations. Raw estimate 124 may be based on information acquired by harvester device 106. Further, raw estimate 124 may be used in the generation of a correction factor as described herein.

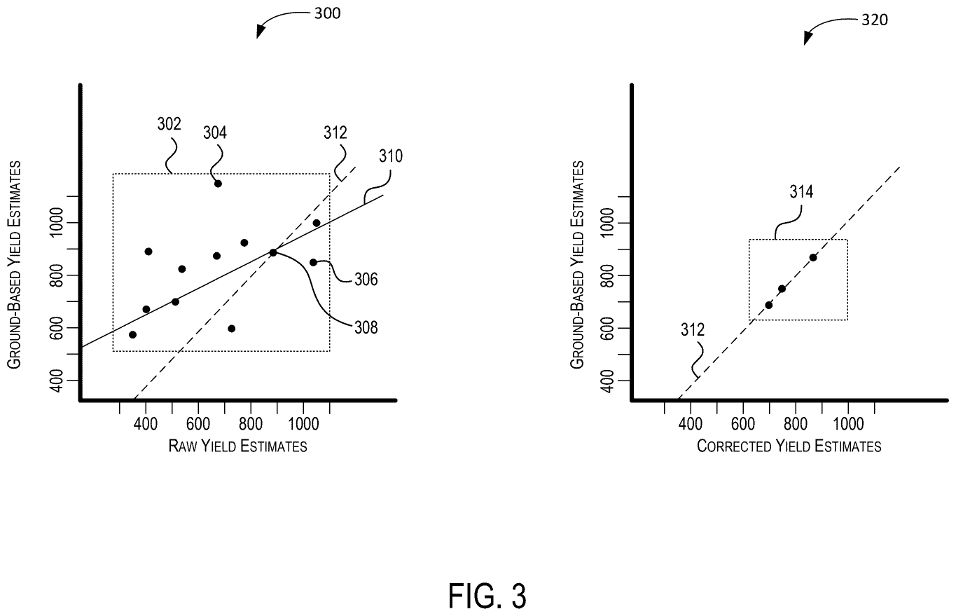

Corrected estimate 126 may comprise an estimated yield of a crop based on samples of a crop variety that were acquired from a plurality of sample locations. For example, a ground-based estimated yield for a corn crop may comprise an estimate of a number of bushels of corn per acre (e.g., one hundred and seventy bushels per acre) for corn in a sample location. Corrected estimate 126 may comprise a plurality of ground-based estimates associated with at least one trait of a crop variety in a plurality of locations. For example, corrected estimate 126 may comprise four yield estimates for wheat at four different sample locations. Corrected estimate 126 may be based on information acquired by harvester device 106. Further, corrected estimate 126 may be used in the generation of a correction factor as described herein (e.g., the generation of a correction factor is described with respect to FIGS. 3-7).

Correction factor 128 may be applied to a variety of crop development estimates associated with a crop trait. For example, correction factor 128 may be used to adjust and improve the accuracy of estimates associated with one or more crop traits comprising crop yield, phenological traits, agronomic traits, plant quality traits, biotic stress traits, and/or abiotic stress traits. Further, correction factor 128 may be applied to estimates for various crops comprising corn, cotton, canola, soybean, wheat, rice, potatoes, sugar cane, linen, hemp, oats, barley, sorghum, various fruits (e.g., apples, pears, strawberries, grapes, bananas, oranges, lemons, limes, watermelon, durian, cantaloupe, and/or plantain), and/or various vegetables (e.g., cucumbers, onions, garlic, carrots, peppers, radishes, cabbage, lettuce, broccoli, olives, peas, and/or tomatoes). Further, correction factor 128 may be used in the generation of a corrected raw estimate as described herein. Correction factor 128 may include the information and/or features of other correction factors described herein.

Planting instructions 130 may be generated by computing system 104 and may include information that indicates one or more times at which a specified quantity of seeds of a crop may be planted at a location. For example, planting instructions 130 may be used by the planting device 110 to plant cotton seeds at a location. Further, planting instructions 130 may comprise information associated with irrigating a crop (e.g., a time and amount of water to apply to a crop). The harvester device 106 may include a mechanized and/or electronic device that may be configured to acquire and/or analyze soil samples from soil of a region in which a crop grows. In some embodiments, the harvester device 106 may gather soil samples from soil used to grow crops including corn, cotton, soybeans, and/or wheat. The harvester device 106 may generate image data 120 based on the soil samples acquired and/or analyzed by the harvester device 106. For example, the harvester device 106 may comprise one or more sensors that may be used to determine the amount of moisture or available water content in a soil sample. The harvester device 106 may include any of the features and/or components of computing system 104. For example, a harvester device 106 may include one or more processors, a memory, one or more input devices, and/or one or more output devices. Further, a harvester device 106 may have different or similar configurations and/or architectures to that of computing system 104.

Image capture device 108 may include a device that comprises one or more image capture devices (e.g., one or more cameras). The one or more image capture devices may be configured to capture one or more images of a location comprising crops. Image capture device 108 may comprise or be associated with a satellite (e.g., a satellite orbiting the Earth) and/or an aircraft comprising an aerial drone, an airplane, and/or an airship (e.g., a dirigible or hot air balloon). Image capture device 108 may be configured to generate first image data by capturing the images from above the plurality of sample locations. For example, the image capture device 108 may comprise an aircraft that is configured with one or more cameras that may be used to capture one or more images of crops from above. Image capture device 108 may generate image data 120 based on the one or more images. Further, image capture device 108 may send image data 120 to computing system 104, which may in turn process the image data 120 as described herein. Image capture device 108 may include any of the features and/or components of computing system 104. For example, an image capture device 108 may include one or more processors, a memory, one or more input devices, and/or one or more output devices. Further, an image capture device 108 may have a configuration and/or architecture includes one or more features of the configuration and/or architecture of computing system 104.

Planting device 110 may include a mechanized and/or electronic device that may be configured to perform operations associated with crop cultivation including planting seeds of a crop. In some embodiments, planting device 110 may plant seeds of one or more crops comprising cotton, corn, canola, soybeans, sugarcane, rice, oats, barley, millet, sorghum, rye, peanuts, almonds, pecans, walnuts, cashews, apples, oranges, sunflowers, canola, and/or wheat. The planting device 110 may be operate independently (e.g., a self-contained planting device) or may be associated with another device (e.g., the planting device 110 may be towed behind a tractor). Planting device 110 may be configured to receive one or more signals which may comprise planting instructions 130. Further, planting device 110 may be configured to plant one or more seeds of a crop based on planting instructions 130. For example, planting device 110 may plant cottonseeds in a location and quantity and at a time indicated in planting instructions 130. The planting device 110 may include any of the features and/or components of computing system 104. For example, a planting device 110 may include one or more processors, a memory, one or more input devices, and/or one or more output devices. Further, a planting device 110 may have different or similar configurations and/or architectures to that of computing system 104.

Irrigation device 112 may include a mechanized device, electronic device, and/or structures that may be configured to irrigate a crop and/or apply (e.g., spray) fungicide, pesticide (e.g., herbicide or insecticide), and/or other substances onto crops. In some embodiments, the irrigation device 112 may irrigate and/or apply fungicide, pesticide, and/or other substances to one or more crops comprising corn, cotton, soybeans, and/or wheat. The irrigation device 112 may perform surface irrigation (e.g., furrow irrigation) that irrigates crops through use of water channels, localized irrigation in which crops may be irrigated using pipes, drip irrigation in which hoses may be configured to drip water onto crops, and/or sprinkler irrigation in which crops are irrigated by being sprayed. For example, the irrigation device 112 may comprise a plurality of channels that are below ground and through which water may be provided to crops based on planting instructions that indicate times at which to provide specified amounts of water to crops. Irrigation device 112 may include any of the features and/or components of computing system 104. For example, an irrigation device 112 may include one or more processors, a memory, one or more input devices, and/or one or more output devices. Further, an irrigation device 112 may have different or similar configurations and/or architectures to that of computing system 104.

One or more aspects described herein may be embodied in computer-usable, computer-readable data, and/or computer-executable instructions, which may be stored as data and/or instructions in one or more memory devices and/or executed by one or more computing devices and/or other devices described herein. Data and/or instructions may include software applications and/or computer programs that may be used to perform the operations described herein (e.g., generating one or more raw estimates) when executed by one or more processors in a computing device or other device. The data and/or instructions be written in source code that is compiled for execution by a computing device. The computer executable instructions may be stored on a computer readable medium (e.g., a non-transitory computer-readable medium) such as a hard disk, solid state drive, optical disk, removable storage media, solid state memory, and/or RAM. The functionality of the computing applications described herein may be combined or distributed in various embodiments. Further, the functionality of the computing applications described herein may be partly or wholly embodied in firmware or hardware equivalents including integrated circuits and/or field programmable gate arrays (FPGA).

FIG. 2 shows an example of a system comprising one or more machine learning models according to one or more aspects of the disclosure. One or more machine learning models 208 may be implemented on one or more computing systems (e.g., the computing system 104 illustrated in FIG. 1) and/or one or more computing devices according to an embodiment of the invention.

Image data 202 may comprise information associated with one or more images captured by an image capture device (e.g., a camera). Further, one or more portions of image data 202 (e.g., first image data 204 or second image data 206) may be used singly or in combination as an input to one or more machine learning models 208. Image data 202 may comprise metadata that indicates a geographic location and/or time (e.g., time of image capture) associated with an image. Furthermore, metadata of image data 202 may include information associated with a data format of the image data 202 (e.g., whether one or more images of image data 202 are encoded in PNG, TIFF, or JPEG format), a resolution of an image of the first image data (e.g., the number of points (e.g., pixels) in an), and/or an indication of whether an image is a still image or a video stream. Further, image data 202 may comprise one or more images that are represented in two dimensions (e.g., images in which each point of the image has a corresponding length and width coordinate). For example, a two-dimensional top-down image of a crop field may be included in image data 202. Further, image data 202 may comprise one or more three-dimensional images (e.g., images in which each point of an image has a corresponding length, width, and depth coordinate). In some embodiments, image data 202 may be acquired and/or received from an entity that is associated with managing the crop, developing the crop, observing the crop, capturing images of the crop, and/or analyzing the crop (e.g., a farmer, agricultural manager, crop researcher, aircraft pilot, and/or agronomist). Further, the image data 202 may be acquired and/or received from a third-party entity that captures images including one or more images the image data 202 is based on (e.g., satellite imagery providers and/or aerial imagery providers).

As shown in FIG. 2, image data 202 may comprise first image data 204 and/or second image data 206. Image data 202 may be based on data received from a variety of sources (e.g., the image capture device 108 described with respect to FIG. 1 and/or a remote computing system that provides image data). Further, one or more portions of image data 202 may be added or removed.

First image data 204 may comprise images of crops (e.g., a crop variety of a particular genotype of crop) in a plurality of sample locations. Further, first image data 204 may be used as input to one or more machine learning models 208 which may use the first image data 204 to generate plurality of first raw estimates 212. The images of the crops may be associated with at least one trait of the crop variety. In particular, the images of crops may be captured from a particular angle that allows for the determination of at least one trait of the crop variety. For example, images of crops may be captured from a top-down angle in order to facilitate the determination of yield by a machine learning model. By way of further example, images of crops may be captured from an angle in which a profile of crops is visible, which may facilitate the determination of leaf angle by a machine learning model. Further, features associated with certain crop traits may be more suitably captured using different types of image capture devices. Additionally, a distance from which images of a crop are captured and/or an angle from which images of a crop are captured may vary based on the trait with which captured images are associated. For example, plant quality traits of a crop may require images that are captured at a closer distance than yield traits of a crop which may be captured from a further distance.

Second image data 206 may comprise images of crops in a second location (e.g., a location that is different from the plurality of sample locations in which crops associated with first image data 204 were captured). Further, second image data 206 may comprise images of a crop that is of the same crop variety as the crop variety of the crops captured in first image data 204. In some embodiments, second image data 206 may be based on images that were captured within the same time interval (e.g., the same hour or day) as the images of first image data 204. Further, second image data 206 may be used as input to one or more machine learning models 208 which may use the second image data 206 to generate plurality of first raw estimates 212. The plurality of sample locations and the second location (e.g., the second location associated with second image data 206) may be within a predetermined geographic area. For example, the predetermined area may include a one hundred square kilometer area that includes the plurality of sample locations and the second location.

One or more machine learning models 208 may be configured and/or trained to determine one or more raw estimates 210. One or more raw estimates 210 may comprise a plurality of first raw estimates 212 and second raw estimate 214. Determination of raw estimates may be based on one or more machine learning models 208 receiving a portion of image data 202 (e.g., first image data 204 or second image data 206); processing the received portion of image data 202; and generating output comprising raw estimates (e.g., generating the plurality of first raw estimates 212 based on first image data 204 and/or generating second raw estimate 214 based on second image data 206). One or more machine learning models 208 comprise a first machine learning model configured to extract one or more features (e.g., visual features) from the images of the crop variety in the plurality of sample locations. Further, one or more machine learning models 208 may comprise be configured to generate the plurality of first raw estimates 212 based on the one or more features extracted by the first machine learning model. For example, one or more machine learning models 208 may be configured to extract crop cover features (e.g., an area or portion of a sample location that is covered by crops) and/or crop area features (e.g., a total area of a sample location) from the first image data 204.

One or more raw estimates 210 may comprise one or more raw estimates associated with at least one trait of a crop comprising a yield trait, a phenological trait, an agronomic trait, a plant quality trait, a biotic stress trait, and/or an abiotic stress trait. In particular, one or more raw estimates 210 associated with a yield trait may comprise an estimated yield of a crop (e.g., pounds of cotton per acre). Further, one or more raw estimates 210 associated with a phenological trait (e.g., crop flowering and/or maturation) may comprise an estimated date of a crop flowering and/or number of days after planting until a crop matures. One or more raw estimates 210 associated with an agronomic trait may comprise an estimated leaf angle of a crop (e.g., a leaf angle of a crop a predetermined number of days after the crop was planted). The leaf angle of a crop may be positively correlated with crop yield. Further, one or more raw estimates 210 associated with a plant quality trait may comprise an estimated protein content of a crop. For example, one or more raw estimates 210 may comprise an estimated protein content of a wheat crop based on hyperspectral imagery of the wheat crop. Additionally, one or more raw estimates 210 associated with a biotic stress traits (e.g., a crop's resistance to crop damage resulting from fungi, bacteria, viruses, parasites, and/or insects) and/or abiotic stress traits (e.g., a crop's resistance to crop damage resulting from excessively high or low temperature, excessively high or low amounts of water, and/or high salinity) may comprise an estimated portion of a crop that may survive the biotic stress and/or abiotic stress.

One or more raw estimates 210 may be expressed as one or more numeric values associated with a trait. For example, one or more raw estimates 210 may comprise a yield estimate that is expressed as a quantity of a crop (e.g., bushels or pounds) per a unit of area (e.g., an acre or hectare). Further, one or more raw estimates 210 may be expressed as a date and/or time at which some event associated with a crop trait is predicted to occur. For example, one or more raw estimates 210 may comprise an estimated date of boll development of a cotton crop variety.

One or more machine learning models 208 may be configured and/or trained to analyze inputs (e.g., image data 202) and generate one or more raw estimates 210 based on the inputs. One or more machine learning models 208 may, for example, comprise one or more convolutional neural networks (CNNs), one or more random forest models, one or more support vector machines (SVMs), a linear model, and/or a Bayesian hierarchical model. The term machine learning model may be construed as meaning one or more machine learning models any of which may operate singularly or in combination with one or more other machine learning models to perform the operations described herein.

Further, one or more machine learning models 208 may be configured and/or trained using various training techniques including supervised learning, unsupervised learning, semi-supervised learning, and/or reinforcement learning. One or more machine learning models 208 may, for example, comprise parameters that have adjustable weights and fixed biases. As part of the process of configuring and/or training the one or more machine learning models 208, values associated with each of the weights of the one or more machine learning models 208 may be modified based on the extent to which each of the parameters contributes to increasing or decreasing the accuracy of output generated by the one or more machine learning models 208. For example, parameters of one or more machine learning models 208 may correspond to various visual features that are extracted from image data 202. Over a plurality of iterations, and based on inputting training data (e.g., training data comprising visual features based on images of crops) to one or more machine learning models 208, the weighting of each of the parameters may be adjusted based on the extent to which each of the parameters contributes to accurately determining one or more raw estimates for a location (e.g., a plurality of sample locations and/or a second location).

Training the one or more machine learning models 208 may comprise the use of a cost function that may be used to minimize the error between output of the one or more machine learning models 208 and a ground-truth value. For example, one or more machine learning models 208 may receive input comprising training data comprising images similar to images from first image data 204 and/or second image data 206 described herein. Accurate output by one or more machine learning models 208 may include determining one or more raw estimates that match or are very similar to (e.g., within a predetermined range of similarity) one or more ground-truth estimates. Inaccurate output by one or more machine learning models 208 may include determining one or more raw estimates that does not match and/or are very dissimilar to (e.g., outside of a predetermined range of similarity) the one or more ground-truth estimates. Over a plurality of training iterations, the weighting of the parameters of one or more machine learning models 208 may be adjusted until the accuracy of the machine learning model's output reaches some threshold accuracy level (e.g., 99% accuracy). Further, output of one or more machine learning models 208 may comprise one or more scores associated with one or more raw estimates 210.

FIG. 3 shows an example of predictive analysis and the generation of a correction factor for crop yield estimates according to one or more aspects of the disclosure. The operations to determine a correction factor may be implemented by systems and/or devices which may comprise the computing system 104 described with respect to FIG. 1.

As described with respect to FIG. 3, a correction factor may be generated and/or determined in order to adjust and improve estimates associated with a crop trait. In particular, the estimates, which may be based on various techniques described herein (e.g., inputting images of a crop into a machine learning model) may comprise an estimated yield of a crop. A correction factor may be used to adjust the estimated yield and thereby improve the accuracy of the yield estimate. The correction factor may be determined based on a predictive analysis (e.g., linear regression analysis, nonlinear regression analysis, and/or machine learning model based analysis) of data that is based on observations associated with a yield of the crop. For example, a linear regression analysis may be performed on a plurality of estimates associated with the yield of a crop. In particular, a correction factor may be determined based on linear regression analysis of ground-based yield estimates for a crop (e.g., estimates based on samples of a crop acquired by a ground-based device such as a harvester from a plurality of sample locations) and raw yield estimates based on images of a crop (e.g., a cotton crop) of the same variety (e.g., the same genotype). Linear regression analysis may be performed in a variety of ways including simple linear regression analysis or multiple linear regression. The plurality of sample locations and the crop variety may be independent variables in the linear regression analysis. Further, a plurality of raw estimates (e.g., raw estimates associated with a crop trait that are generated based on image data) may be dependent variables in the linear regression analysis. Linear regression analysis may be used to determine one or more relationships between the ground-based yield estimates and the raw yield estimates. For example, the linear regression analysis may be used to determine the extent to which a plurality of raw yield estimates are similar to a plurality of ground-based yield estimates. Further, a discrepancy between the plurality of raw yield estimates and the plurality of ground-based yield estimates may be used to determine a correction factor.

The correction factor determined from the linear regression analysis may be used to adjust raw yield estimates. For example, a correction factor may be used to adjust raw yield estimates based on output from a machine-learning model that generated the raw yield estimates based on input comprising images of crops at a sample location. The correction factor may be used to adjust the raw yield estimates to be more similar to what a ground-based yield estimate for that sample location would be. For example, if a raw yield estimate for cotton yield is 1200 pounds of cotton per acre and a ground-based yield estimate for the same sample is 900 pounds of cotton per acre, a correction factor of 0.75 (or other value greater than or less than the illustrative 0.75) may be used to adjust the raw yield estimate to match the ground-based yield estimate. The correction factor for the specific genotype of a crop may then be used to adjust the raw yield estimates for that specific genotype of a crop at a different location.

In FIG. 3, each of a plurality of datapoints 302 may be associated with a respective plurality of sample locations from which raw yield estimates and ground-based yield estimates for a crop variety were determined. Further, a plurality of values associated with the y-axis of raw estimates 300 may be associated with ground-based yield estimates and a plurality of values associated with the x-axis of raw estimates 300 may be associated with raw yield estimates for the same variety (e.g., the same genotype) of crop at the same location.

For example, plurality of datapoints 302 may comprise datapoint 304, datapoint, 306, and datapoint 308. Each of the plurality of datapoints 302 may be associated with a ground-based yield and a raw yield estimate for a specific variety (e.g., a single genotype) of a crop at a different sample location. In particular, datapoint 304 may be associated with a raw yield estimate of 675 pounds per acre and a ground-based yield estimate of 1020 pounds per acre for a crop at a first location, datapoint 306 may be associated with a raw yield estimate of 1040 pounds per acre and a ground-based yield estimate of 720 pounds per acre at a second location, and datapoint 308 may be associated with a raw yield estimate of 880 pounds per acre and a ground-based yield estimate of 880 pounds per acre at a third location. In this example, some of the raw yield estimates and ground-based yield estimates for a location may be different. For example, as shown in FIG. 3, the raw yield estimate for the crop at the first location associated with the datapoint 304 is lower than the ground-based yield estimate at the first location. The difference between the raw yield estimate and the ground-based yield estimate may be the result of differences between the sample locations. Given that the variety of the crop is the same at each of the plurality of sample locations, some of the differences between the ground-based yield estimates at the difference sample locations may be the result of factors other than the variety of the crop species. These factors may comprise differences in the environment (e.g., temperature, humidity, rainfall, soil conditions, amount of sunshine) and/or agronomic techniques (e.g., type of pesticide used, and/or type of fertilizer used) at the locations in which crops are grown.

Linear regression analysis of plurality of datapoints 302 may comprise determining an intercept and a line of best fit 310 that is based on and passes through the plurality of datapoints 302. The intercept may comprise a datapoint at which a value of the ground-based yield estimate corresponds to a raw yield estimate of zero. For example, based on the plurality of datapoints 302, a datapoint in which the raw yield estimate is 0 pounds of cotton per acre may have a corresponding ground-based yield estimate of approximately 200 pounds of cotton per acre. Further, determining line of best fit 310 may comprise determining a line that minimizes the sum of the squares of the error (e.g., the square of the error based on the differences between raw yield estimates and ground-based yield estimates for each of the plurality of datapoints 302).

Line 312 may be based on a set of datapoints in which raw yield estimates are equal to the ground-based yield estimates. Of the plurality of datapoints 308, the datapoint 308 is a datapoint in which the raw yield estimate and the ground-based yield estimate have a similar value of approximately 880 pounds per acre. As shown in FIG. 3, the remaining datapoints (the plurality of datapoints 302 excluding datapoint 308) of the plurality of datapoints 302 have raw yield estimates that are not the same as their respective ground-based yield estimates.

A correction factor may be determined based on the differences between the line of best fit 310 and the line 312. In this example, line of best fit 310 comprises raw yield estimates that are less than the ground-based yield estimates when the raw yield estimate is less than 880 pounds per acre. When the raw yield estimate is greater than 880 pounds per acre, the raw yield estimate is greater than the ground-based yield estimate for the same location. The correction factor may increase a raw yield estimate when a raw yield estimate is less than 880 pounds per acre and decrease a raw yield estimate when a raw yield estimate is greater than 880 pounds per acre. As shown FIG. 3, corrected estimates 320 may be based on fitting or applying a correction factor (e.g., a correction factor determined using the linear regression analysis described herein) to raw yield estimates and resulting in corrected yield estimates comprising a plurality of datapoints 314 based on cotton from a plurality of sample locations that are not associated with the plurality of datapoints 302. As shown in the corrected estimates 320, datapoints 314 closely correspond to line 312, which indicates that the correction factor improves the accuracy of raw estimated yields from locations not associated with the plurality of datapoints 302. As such, the correction factor may be used to improve the accuracy of generating raw estimated yields for a crop variety.

The correction factor may be used to adjust crop development estimates with respect to agronomic traits comprising an estimate with respect to a leaf angle (e.g., the angle between the midrib of a leaf blade of a crop and the stem of the crop) of a crop. For example, a crop (e.g., corn) may be estimated to have a certain angle a certain number of days after seeds of the crop are planted. The correction factor may be based on analysis of images of the crop and ground-based samples of the crop from sample locations that is used to generate a correction factor that may be applied to image-based estimates of the time at which the leaf angle of the crop will reach a predetermined leaf angle.

The correction factor may be used to adjust crop development estimates with respect to plant quality traits. For example, a crop (e.g., apple) may be estimated to ripen a certain number of days after seeds of the crop are planted. The ripeness of the crop may be based on the color (e.g., a banana changing from green to yellow) of the crop at an estimated time. The correction factor may be based on analysis of images of the crop and ground-based samples of the crop from sample locations that is used to generate a correction factor that may be applied to image-based estimates of the time at which the crop will achieve some quality criteria.

The correction factor may be used to adjust crop development estimates with respect to biotic stress traits and/or abiotic stress traits comprising an estimate with respect to a crop's response to stresses comprising drought, heat, high salinity, and/or disease. For example, a crop (e.g., rice) may be estimated to have a lower yield in response to deficient water conditions. The correction factor may be based on analysis of images of the crop and ground-based samples of the crop from sample locations that is used to generate a correction factor that may be applied to image-based estimates of the time at which the crop will achieve an estimated yield under the stressful conditions.

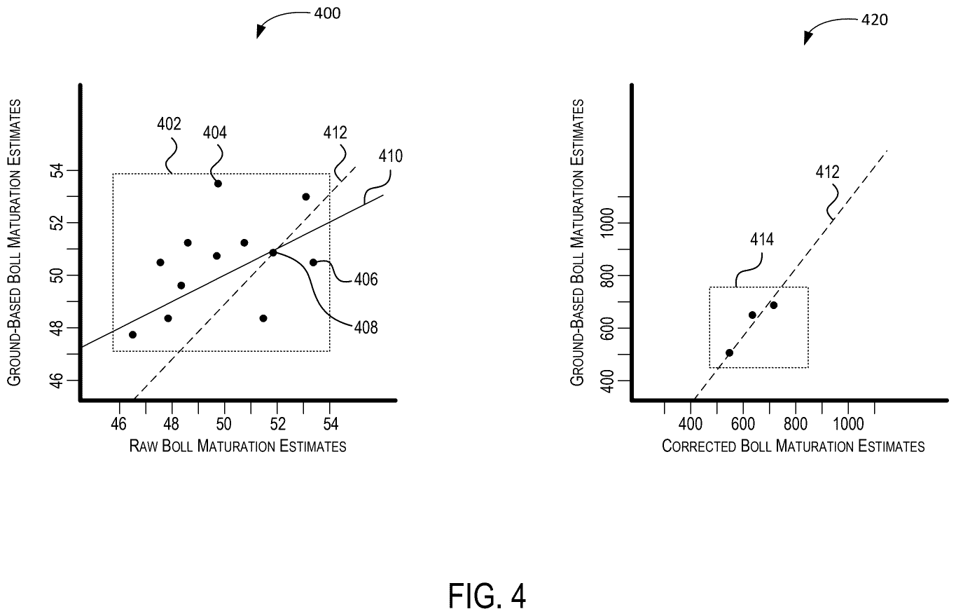

FIG. 4 shows an example of predictive analysis and the generation of a correction factor for estimates associated with phenological traits of a crop according to one or more aspects of the disclosure. The operations to generate a correction factor may be implemented by systems and/or devices which may comprise the computing system 104 described with respect to FIG. 1.

Similar to the description of generating a correction factor with respect to FIG. 3, a correction factor may be generated in order to adjust and improve estimates associated with phenological traits of a crop. The correction factor may be generated based on predictive analysis (e.g., linear regression analysis, nonlinear regression analysis, and/or machine learning model based analysis) of data that is based on observations associated with phenological traits of the crop. The correction factor may be used to adjust crop development estimates with respect to phenological traits comprising an estimate of a time at which a crop will flower or mature. For example, a crop (e.g., cotton) may be estimated to flower or mature a certain number of days after seeds of the crop are planted. In particular, a correction factor may be determined based on linear regression analysis of ground-based crop maturation (e.g., cotton boll maturation after fertilization) estimates for a crop (e.g., estimates based on samples of cotton acquired by a ground-based device such as a harvester) and raw boll maturation estimates based on images of a crop (e.g., a cotton crop) of the same variety (e.g., the same genotype). The linear regression analysis may be used to determine one or more relationships between the ground-based boll maturation estimates and the raw boll maturation estimates. For example, the linear regression analysis may be used to determine the extent to which a plurality of raw boll maturation estimates are similar to a plurality of ground-based boll maturation estimates. Further, a discrepancy between the plurality of raw boll maturation estimates and the plurality of ground-based boll maturation estimates may be used to determine a correction factor.

The correction factor determined from the linear regression analysis may be used to adjust raw boll maturation estimates. For example, a correction factor may be used to adjust raw boll maturation estimates based on output from a machine-learning model that generated the raw boll maturation estimates based on input comprising images of cotton crops at a sample location. The correction factor may be used to adjust the raw boll maturation estimates to be more similar to what a ground-based boll maturation estimate for that sample location would be. For example, if a raw boll maturation estimate for cotton boll maturation is 50 days after fertilization of a cotton crop and a ground-based boll maturation estimate for the same sample is 52 days after fertilization of a cotton crop of the same variety, a correction factor of 1.04 may be used to adjust the raw boll maturation estimate to match the ground-based boll maturation estimate. As described herein, a correction factor for a specific genotype of a cotton crop may be used to adjust the raw boll maturation estimates for that specific genotype of a crop at a different location.

In FIG. 4, each of a plurality of datapoints 402 may be associated with a respective plurality of sample locations from which raw boll maturation estimates and ground-based boll maturation estimates for a crop variety were determined. Further, a plurality of values associated with the y-axis of raw estimates 400 may be associated with ground-based boll maturation estimates and a plurality of values associated with the x-axis of raw estimates 400 may be associated with raw boll maturation estimates for the same variety (e.g., the same genotype) of crop at the same location.

For example, plurality of datapoints 402 may comprise datapoint 404, datapoint, 406, and datapoint 408. Each of the plurality of datapoints 402 may be associated with a ground-based boll maturation and a raw boll maturation estimate for a specific variety of a crop at a different sample location. In particular, datapoint 404 may be associated with a raw boll maturation estimate of approximately 49 days after fertilization of a cotton crop and a ground-based boll maturation estimate of approximately 53 days after fertilization of a cotton crop for a crop at a first location, datapoint 406 may be associated with a raw boll maturation estimate of approximately 53 days after fertilization of a cotton crop and a ground-based boll maturation estimate of approximately 50 days after fertilization of a cotton crop at a second location, and datapoint 408 may be associated with a raw boll maturation estimate of approximately 51 days after fertilization of a cotton crop and a ground-based boll maturation estimate of approximately 51 days after fertilization of a cotton crop at a third location. In this example, some of the raw boll maturation estimates and ground-based boll maturation estimates may be different for some of the locations associated with the plurality of datapoints 402. For example, as shown in FIG. 4, the raw boll maturation estimate for the crop at the first location associated with the datapoint 404 is lower than the ground-based boll maturation estimate at the first location. Differences between a raw boll maturation estimate and a ground-based boll maturation estimate may be the result of differences in growing conditions at the sample locations (e.g., differences in environmental conditions and/or agronomic practices as described with respect to FIG. 3).

Linear regression analysis of plurality of datapoints 402 may, similarly to the linear regression analysis described with respect to FIG. 3, comprise determining an intercept and a line of best fit 410 that passes through the plurality of datapoints 402. Line 412 may be based on a set of datapoints in which raw boll maturation estimates are equal to ground-based boll maturation estimates. Of the plurality of datapoints 408, the datapoint 408 is a datapoint in which the raw boll maturation estimate and the ground-based boll maturation estimate have a similar value of approximately 880 days after fertilization of a cotton crop. As shown in FIG. 4, the remaining datapoints (the plurality of datapoints 402 excluding datapoint 408) of the plurality of datapoints 402 have raw boll maturation estimates that are not the same as their respective ground-based boll maturation estimates.

Similar to the linear regression analysis described with respect to FIG. 3, a correction factor may be determined based on the differences between line of best fit 410 and the line 412. As shown in FIG. 4, corrected estimates 420 may be based on fitting on fitting or applying a correction factor to raw boll maturation estimates which may result in corrected boll maturation estimates comprising a plurality of datapoints 414 that are associated with cotton from a plurality of sample locations that are not associated with the plurality of datapoints 402. As shown in the corrected estimates 420, datapoints 414 closely correspond to line 412, which indicates that the correction factor improves the accuracy of raw estimated boll maturations from locations not associated with the plurality of datapoints 402. As such, the correction factor may be used to improve the accuracy of generating raw estimated boll maturations for a crop variety.

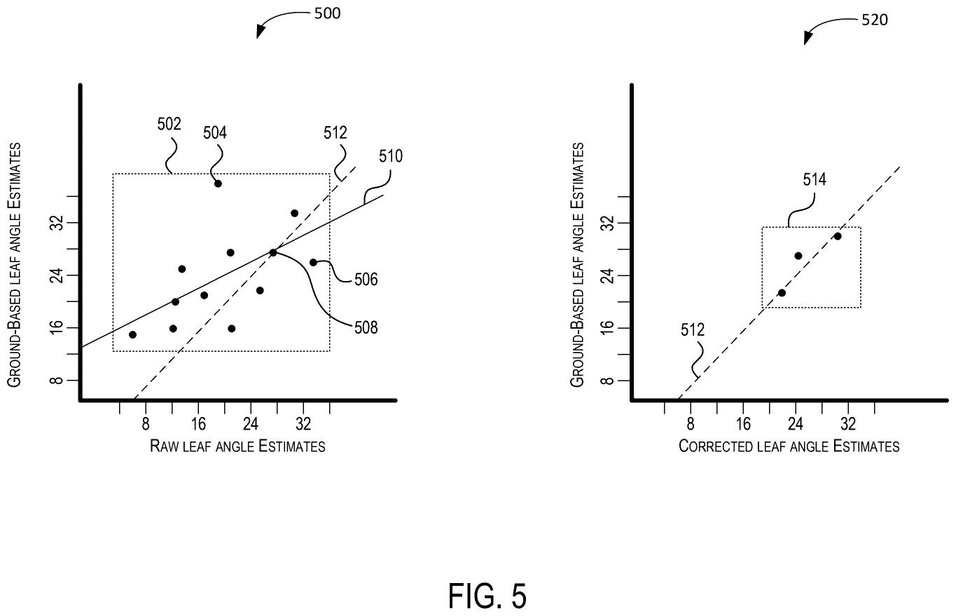

FIG. 5 shows an example of predictive analysis and generating a correction factor for estimates associated with agronomic traits of a crop according to one or more aspects of the disclosure. The operations to generate a correction factor may be implemented by systems and/or devices which may comprise the computing system 104 described with respect to FIG. 1.

Similar to the description of generating a correction factor with respect to FIG. 3, a correction factor may be generated in order to adjust and improve estimates associated with agronomic traits of a crop. The correction factor may be generated based on predictive analysis (e.g., linear regression analysis, nonlinear regression analysis, and/or machine learning model based analysis) of data that is based on observations associated with agronomic traits of the crop. The correction factor may be used to adjust crop development estimates with respect to agronomic traits comprising an estimated leaf angle (e.g., the angle between the midrib of a leaf blade of a crop and the stem of the crop) of a crop. For example, a crop (e.g., corn) may be estimated to have a certain leaf angle at a certain phase in the development cycle of the crop. Leaf angle may change the amount of sunlight that is captured by a crop and may be associated with crop growth. A correction factor may be determined based on linear regression analysis of ground-based leaf angle estimates (e.g., corn leaf angle a predetermined number of days after planting) for a crop (e.g., estimates based on samples of corn acquired by a ground-based device such as a corn harvester) and raw leaf angle estimates based on images of a crop (e.g., a corn crop) of the same variety (e.g., the same genotype). Linear regression analysis may be used to determine one or more relationships between the ground-based leaf angle estimates and the raw leaf angle estimates. For example, the linear regression analysis may be used to determine the extent to which a plurality of raw leaf angle estimates are similar to a plurality of ground-based leaf angle estimates. Further, a discrepancy between the plurality of raw leaf angle estimates and the plurality of ground-based leaf angle estimates may be used to determine a correction factor.

The correction factor determined from the linear regression analysis may be used to adjust raw leaf angle estimates. For example, a correction factor may be used to adjust raw leaf angle estimates based on output from a machine-learning model that generated the raw leaf angle estimates based on input comprising images of corn crops at a sample location. The correction factor may be used to adjust the raw leaf angle estimates to be more similar to what a ground-based leaf angle estimate for that sample location would be. For example, if a raw leaf angle estimate for corn leaf angle is 24 degrees when measured 90 days after planting of a corn crop and a ground-based leaf angle estimate for the same sample is 28 degrees when measured 90 days after planting of a corn crop of the same variety, a correction factor of 0.85 may be used to adjust the raw leaf angle estimate to match the ground-based leaf angle estimate. As described herein, a correction factor for a specific genotype of a corn crop may be used to adjust the leaf angle estimates for that specific genotype of a crop at a different location.

In FIG. 5, each of a plurality of datapoints 502 may be associated with a respective plurality of sample locations from which raw leaf angle estimates and ground-based leaf angle estimates for a crop variety were determined. Further, a plurality of values associated with the y-axis of raw estimates 500 may be associated with ground-based leaf angle estimates and a plurality of values associated with the x-axis of raw estimates 500 may be associated with raw leaf angle estimates for the same variety (e.g., the same genotype) of crop at the same location.

For example, plurality of datapoints 502 may comprise datapoint 504, datapoint 506, and datapoint 508. Each of the plurality of datapoints 502 may be associated with a ground-based leaf angle and a raw leaf angle estimate for a specific variety of a crop at a different sample location. In particular, datapoint 504 may be associated with a raw leaf angle estimate of approximately 20 degrees after planting of a corn crop and a ground-based leaf angle estimate of approximately 36 degrees after planting of a corn crop for a crop at a first location, datapoint 506 may be associated with a raw leaf angle estimate of approximately 34 degrees after planting of a corn crop and a ground-based leaf angle estimate of approximately 26 degrees 90 days after planting of a corn crop at a second location, and datapoint 508 may be associated with a raw leaf angle estimate of approximately 28 degrees 90 days after planting of a corn crop and a ground-based leaf angle estimate of approximately 28 degrees 90 days after planting of a corn crop at a third location. In this example, some of the raw leaf angle estimates and ground-based leaf angle estimates may be different for some of the locations associated with the plurality of datapoints 502. For example, as shown in FIG. 5, the raw leaf angle estimate for the crop at the first location associated with the datapoint 504 is lower than the ground-based leaf angle estimate at the first location. Differences between a raw leaf angle estimate and a ground-based leaf angle estimate may be the result of differences in growing conditions at the sample locations (e.g., differences in environmental conditions and/or agronomic practices as described with respect to FIG. 3).

Linear regression analysis of plurality of datapoints 502 may, similarly to the linear regression analysis described with respect to FIG. 3, comprise determining an intercept and a line of best fit 510 that passes through the plurality of datapoints 502. Line 512 may be based on a set of datapoints in which raw leaf angle estimates are equal to ground-based leaf angle estimates. Of the plurality of datapoints 508, the datapoint 508 is a datapoint in which the raw leaf angle estimate and the ground-based leaf angle estimate have a similar value of approximately 28 degrees 90 days after planting of a corn crop. As shown in FIG. 5, the remaining datapoints (the plurality of datapoints 502 excluding datapoint 508) of the plurality of datapoints 502 have raw leaf angle estimates that are not the same as their respective ground-based leaf angle estimates.

Similar to the linear regression analysis described with respect to FIG. 3, a correction factor may be determined based on the differences between line of best fit 510 and the line 512. As shown in FIG. 5, corrected estimates 520 may be based on fitting or applying a correction factor raw leaf angle estimates which may result in corrected leaf angle estimates comprising a plurality of datapoints 514 which are based on corn from a plurality of sample locations that are not associated with the plurality of datapoints 502. As shown in the corrected estimates 520, datapoints 514 closely correspond to line 512, which indicates that the correction factor improves the accuracy of raw estimated leaf angles from locations not associated with the plurality of datapoints 502. As such, the correction factor may be used to improve the accuracy of generating raw estimated leaf angles for a crop variety.

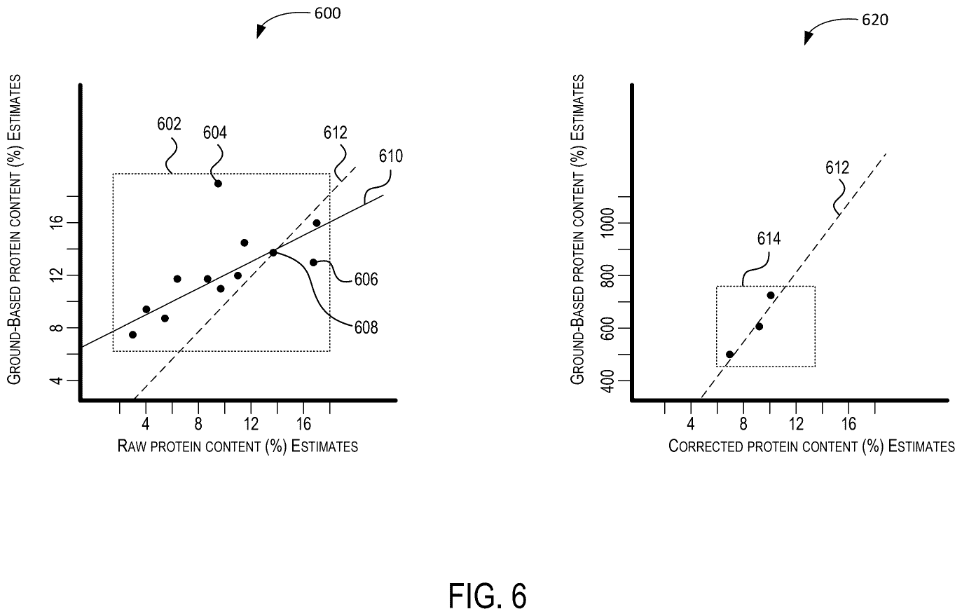

FIG. 6 shows an example of predictive analysis and generating a correction factor for estimates associated with plant quality traits of a crop according to one or more aspects of the disclosure. The operations to generate a correction factor may be implemented by systems and/or devices which may comprise the computing system 104 described with respect to FIG. 1.

Similar to the description of generating a correction factor with respect to FIG. 3, a correction factor may be generated in order to adjust and improve estimates associated with plant quality traits of a crop. The correction factor may be generated based on predictive analysis (e.g., linear regression analysis, nonlinear regression analysis, and/or machine learning model based analysis) of data that is based on observations associated with plant quality traits of the crop. The correction factor may be used to adjust crop development estimates with respect to plant quality traits comprising an estimate of a crop's protein content. For example, a crop (e.g., wheat) may be estimated to have a certain protein content when the crop has matured (e.g., 120 days after planting for wheat planted during the spring or 240 days after planting for wheat planted during the winter). In particular, a correction factor may be determined based on linear regression analysis of ground-based crop maturation (e.g., wheat protein content after planting) estimates for a crop (e.g., estimates based on samples of wheat acquired by a ground-based device such as a harvester) and raw protein content estimates based on images of a crop (e.g., a wheat crop) of the same variety (e.g., the same genotype). The linear regression analysis may be used to determine one or more relationships between the ground-based protein content estimates and the raw protein content estimates. For example, the linear regression analysis may be used to determine the extent to which a plurality of raw protein content estimates are similar to a plurality of ground-based protein content estimates. Further, a discrepancy between the plurality of raw protein content estimates and the plurality of ground-based protein content estimates may be used to determine a correction factor.

The correction factor determined from the linear regression analysis may be used to adjust raw protein content estimates. For example, a correction factor may be used to adjust raw protein content estimates based on output from a machine-learning model that generated the raw protein content estimates based on input comprising images of wheat crops at a sample location. The correction factor may be used to adjust the raw protein content estimates to be more similar to what a ground-based protein content estimate for that sample location would be. For example, if a raw protein content estimate for wheat protein content is 10 percent when the wheat crop is mature and a ground-based protein content estimate for the same sample is 12 percent when a wheat crop of the same variety is mature, a correction factor of 1.2 may be used to adjust the raw protein content estimate to match the ground-based protein content estimate. As described herein, a correction factor for a specific genotype of a wheat crop may be used to adjust the raw protein content estimates for that specific genotype of a crop at a different location.

In FIG. 6, each of a plurality of datapoints 602 may be associated with a respective plurality of sample locations from which raw protein content estimates and ground-based protein content estimates for a crop variety were determined. Further, a plurality of values associated with the y-axis of raw estimates 600 may be associated with ground-based protein content estimates and a plurality of values associated with the x-axis of raw estimates 600 may be associated with raw protein content estimates for the same variety (e.g., the same genotype) of crop at the same location.

For example, plurality of datapoints 602 may comprise datapoint 604, datapoint, 606, and datapoint 608. Each of the plurality of datapoints 602 may be associated with a ground-based protein content and a raw protein content estimate for a specific variety of a crop at a different sample location. In particular, datapoint 604 may be associated with a raw protein content estimate of approximately 10 percent when the wheat crop is mature and a ground-based protein content estimate of approximately 18 percent when a wheat crop of the same variety is mature at a first location, datapoint 606 may be associated with a raw protein content estimate of approximately 17 percent when the wheat crop is mature and a ground-based protein content estimate of approximately 13 percent when a wheat crop of the same variety is mature at a second location, and datapoint 608 may be associated with a raw protein content estimate of approximately 14 percent when a wheat crop is mature and a ground-based protein content estimate of approximately 14 percent when a wheat crop of the same variety is mature at a third location. In this example, some of the raw protein content estimates and ground-based protein content estimates may be different for some of the locations associated with the plurality of datapoints 602. For example, as shown in FIG. 6, raw protein content estimate for the crop at the first location associated with the datapoint 604 is lower than the ground-based protein content estimate at the first location. Differences between a raw protein content estimate and a ground-based protein content estimate for crops of the same variety may be the result of differences in growing conditions at the sample locations (e.g., differences in environmental conditions and/or plant quality practices as described with respect to FIG. 3).

Linear regression analysis of plurality of datapoints 602 may, similarly to the linear regression analysis described with respect to FIG. 3, comprise determining an intercept and a line of best fit 610 that passes through the plurality of datapoints 602. Line 612 may be based on a set of datapoints in which raw protein content estimates are equal to ground-based protein content estimates. Of the plurality of datapoints 608, the datapoint 608 is a datapoint in which the raw protein content estimate and the ground-based protein content estimate have a similar value of approximately 14 percent when the wheat crop is mature. As shown in FIG. 6, the remaining datapoints (the plurality of datapoints 602 excluding datapoint 608) of the plurality of datapoints 602 have raw protein content estimates that are not the same as their respective ground-based protein content estimates.

Similar to the linear regression analysis described with respect to FIG. 3, a correction factor may be determined based on the differences between line of best fit 610 and the line 612. As shown in FIG. 6, corrected estimates 620 may be based on fitting or applying a correction factor to raw protein content estimates which may result in corrected protein content estimates comprising a plurality of datapoints 614 based on for wheat from a plurality of sample locations that are not associated with the plurality of datapoints 602. As shown in the corrected estimates 620, datapoints 614 closely correspond to line 612, which indicates that the correction factor improves the accuracy of generating raw estimated protein contents from locations not associated with the plurality of datapoints 602. As such, the correction factor may be used to improve the accuracy of generating raw estimated protein contents for a crop variety.

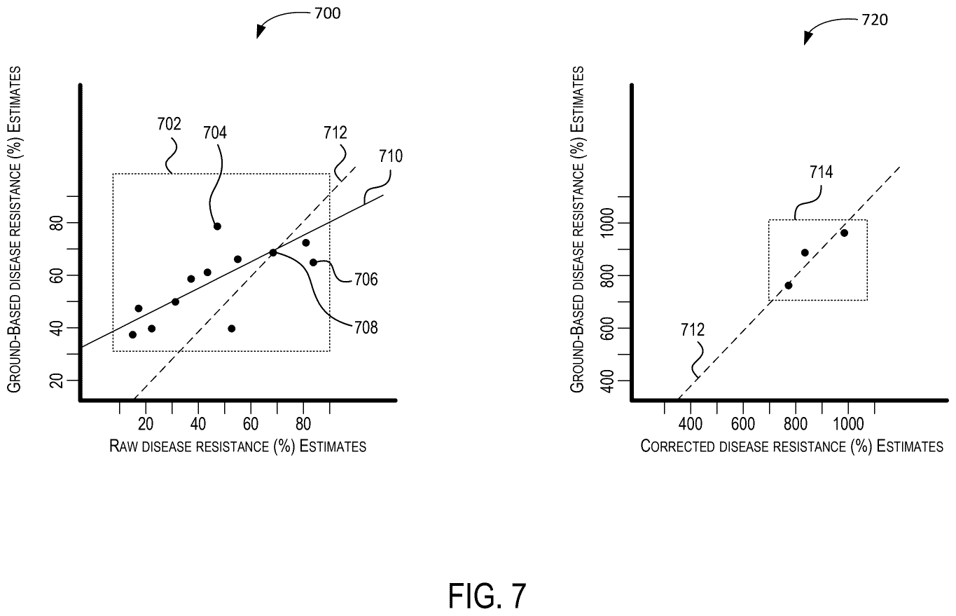

FIG. 7 shows an example of predictive analysis and generating a correction factor for estimates associated with biotic stress traits or abiotic stress traits of a crop according to one or more aspects of the disclosure. The operations to generate a correction factor may be implemented by systems and/or devices which may comprise the computing system 104 described with respect to FIG. 1.

Similar to the description of generating a correction factor with respect to FIG. 3, a correction factor may be generated in order to adjust and improve estimates associated with biotic stress traits or abiotic stress traits of a crop. The correction factor may be generated based on predictive analysis (e.g., linear regression analysis, nonlinear regression analysis, and/or machine learning model based analysis) of data that is based on observations associated with biotic traits of the crop. The correction factor may be used to adjust crop development estimates with respect to biotic stress traits comprising a crop's estimated resistance to one or more diseases (e.g., brown spot fungal disease in rice) based on disease severity (e.g., reduction in crop yield resulting from the disease). In particular, a correction factor may be determined based on linear regression analysis of ground-based estimates disease severity (e.g., disease severity in rice 60 days after planting) for a crop (e.g., estimates based on samples of rice acquired by a ground-based device such as a rice harvester) and raw disease severity estimates based on images of a crop (e.g., a rice crop) of the same variety (e.g., the same genotype). The linear regression analysis may be used to determine one or more relationships between the ground-based disease severity estimates and the raw disease severity estimates. For example, the linear regression analysis may be used to determine an extent to which a plurality of raw disease severity estimates are similar to a plurality of ground-based disease severity estimates. Further, a discrepancy between the plurality of raw disease severity estimates and the plurality of ground-based disease severity estimates may be used to determine a correction factor.

The correction factor determined from the linear regression analysis may be used to adjust raw disease severity estimates. For example, a correction factor may be used to adjust raw disease severity estimates based on output from a machine-learning model that generated the raw disease severity estimates based on input comprising images of rice crops at a sample location. The correction factor may be used to adjust the raw disease severity estimates to be more similar to what a ground-based disease severity estimate for that sample location would be. For example, if a raw disease severity estimate for rice disease severity is 20 percent 60 days after planting of a rice crop and a ground-based disease severity estimate for the same sample is 25 percent 60 days after planting of a rice crop of the same variety, a correction factor of 1.25 may be used to adjust the raw disease severity estimate to match the ground-based disease severity estimate. As described herein, a correction factor for a specific genotype of a rice crop may be used to adjust the raw disease severity estimates for that specific genotype of a crop at a different location.

In FIG. 7, each of a plurality of datapoints 702 may be associated with a respective plurality of sample locations from which raw disease severity estimates and ground-based disease severity estimates for a crop variety were determined. Further, a plurality of values associated with the y-axis of raw estimates 700 may be associated with ground-based disease severity estimates and a plurality of values associated with the x-axis of raw estimates 700 may be associated with raw disease severity estimates for the same variety (e.g., the same genotype) of crop at the same location.

For example, plurality of datapoints 702 may comprise datapoint 704, datapoint, 706, and datapoint 708. Each of the plurality of datapoints 702 may be associated with a ground-based disease severity and a raw disease severity estimate for a specific variety of a crop at a different sample location. In particular, datapoint 704 may be associated with a raw disease severity estimate of approximately 48 percent 60 days after planting of a rice crop and a ground-based disease severity estimate of approximately 76 percent 60 days after planting of a rice crop for a crop at a first location, datapoint 706 may be associated with a raw disease severity estimate of approximately 84 percent 60 days after planting of a rice crop and a ground-based disease severity estimate of approximately 65 percent at a time 60 days after planting of a rice crop at a second location, and datapoint 708 may be associated with a raw disease severity estimate of approximately 68 percent at a time 60 days after planting of a rice crop and a ground-based disease severity estimate of approximately 68 percent at a time 60 days after planting of a rice crop at a third location. In this example, some of the raw disease severity estimates and ground-based disease severity estimates may be different for some of the locations associated with the plurality of datapoints 702. For example, as shown in FIG. 7, the raw disease severity estimate for the crop at the first location associated with the datapoint 704 is lower than the ground-based disease severity estimate at the first location. Differences between a raw disease severity estimate and a ground-based disease severity estimate may be the result of differences in growing conditions at the sample locations (e.g., differences in environmental conditions and/or agronomic practices as described with respect to FIG. 3).

Linear regression analysis of plurality of datapoints 702 may, similarly to the linear regression analysis described with respect to FIG. 3, comprise determining an intercept and a line of best fit 710 that passes through the plurality of datapoints 702. Line 712 may be based on a set of datapoints in which raw disease severity estimates are equal to ground-based disease severity estimates. Of the plurality of datapoints 708, the datapoint 708 is a datapoint in which the raw disease severity estimate and the ground-based disease severity estimate have a similar value of approximately 68 percent at a time 60 days after planting of a rice crop. As shown in FIG. 7, the remaining datapoints (the plurality of datapoints 702 excluding datapoint 708) of the plurality of datapoints 702 have raw disease severity estimates that are not the same as their respective ground-based disease severity estimates.

Similar to the linear regression analysis described with respect to FIG. 3, a correction factor may be determined based on the differences between line of best fit 710 and the line 712. As shown in FIG. 7, corrected estimates 720 may be based on fitting or applying a correction factor to raw disease severity estimates which may result in corrected disease severity estimates comprising a plurality of datapoints 714 based on for rice from a plurality of sample locations that are not associated with the plurality of datapoints 702. As shown in the corrected estimates 720, datapoints 714 closely correspond to line 712, which indicates that the correction factor improves the accuracy of raw estimated disease severity from locations not associated with the plurality of datapoints 702. As such, the correction factor may be used to improve the accuracy of generating raw estimated disease severity for a crop variety.

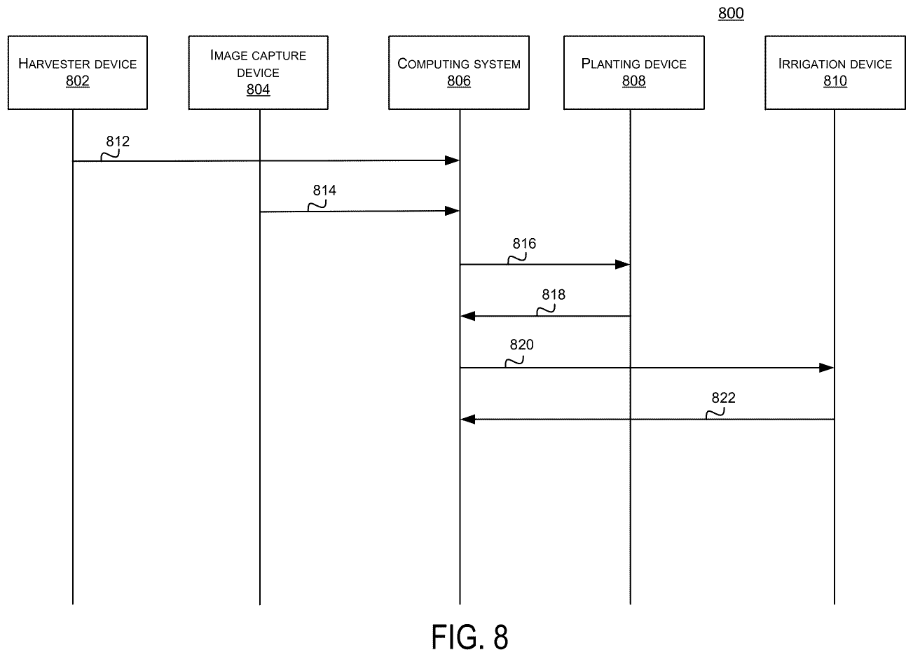

FIG. 8 shows a timing diagram that indicates a data flow of signals associated with generating and sending planting instructions in accordance with aspects of the present disclosure. Computing devices and/or systems associated with data flow 800 may include any of the features and/or components of the computing system 104, harvester device 106, image capture device 108, planting device 110, and/or irrigation device 112, which are described with respect to FIG. 1. Further, the operations performed as part of the data flow 800 may be performed by the computing systems and/or computing devices described herein.

The harvester 802 (e.g., a mechanized harvester that is configured to harvest crops) may send a signal 812 that includes information associated with ground-based yields of a crop that was harvested by the harvester 802. The harvester 802 may generate the ground-based yield data and send signal 812 comprising the ground-based yield data to computing system 806.

The image capture device 804 (e.g., an aerial drone configured to capture images of crop fields) may generate image data associated with the captured images of the crops. Further, the image capture device 804 may send signal 814 comprising the image data to computing system 806.

The computing system 806 may be configured to receive the signal 812 and/or the signal 814. In this example, the computing system 806 may generate raw yield estimates based on the image data associated with the signal 814. Further, the computing system 806 may use a correction factor (e.g., a correction factor generated as described herein) to generate a corrected yield estimate based on the raw yield estimate. The computing system 806 may generate planting instructions based on the corrected yield estimate. The planting instructions may comprise instructions for planting and/or irrigating a crop. The computing system 806 may send a signal 816 (e.g., a signal including planting instructions) to the planting device 808. The signal 816 may comprise the corrected yield estimate. Further, the planting device 808 may in turn send a signal 818 (e.g., a signal confirming receipt of the planting instructions in the signal 816) to the computing system 806. Further, the planting device 808 may perform operations comprising planting seeds of a crop based on the planting instructions included in the signal 816. In other embodiments, the corrected yield estimate calculated by the computing system 806 using a correction factor (e.g., a correction factor generated as described herein) may cause a signal other than signal 816 to be sent. For example, the correction factor may be used to populate an electronic spreadsheet or dashboard GUI with corrected yield estimates to, among other things, validate plans in preparation for planting and/or irrigating a plot of land (e.g., at a new, second location). In some examples, an analytics group at an organization may use the electronic spreadsheet to prepare projections and forecasts for the aforementioned plot of land. The analytics group (or other user) may also use the electronic spreadsheet to select from among different plot of lands using the electronic spreadsheet. The output of the computing system 806 is not limited to communicating signal 816 to just a planting device 808, but this disclosure contemplates numerous uses for the output.

The computing system 806 may send a signal 820 (e.g., a signal including planting instructions) to the irrigation device 810. The irrigation device 810 may send a signal 818 (e.g., a signal confirming receipt of the planting instructions in the signal 816) to the computing system 806. Further, the irrigation device 810 may perform operations comprising irrigating a crop based on the planting instructions included in the signal 820.

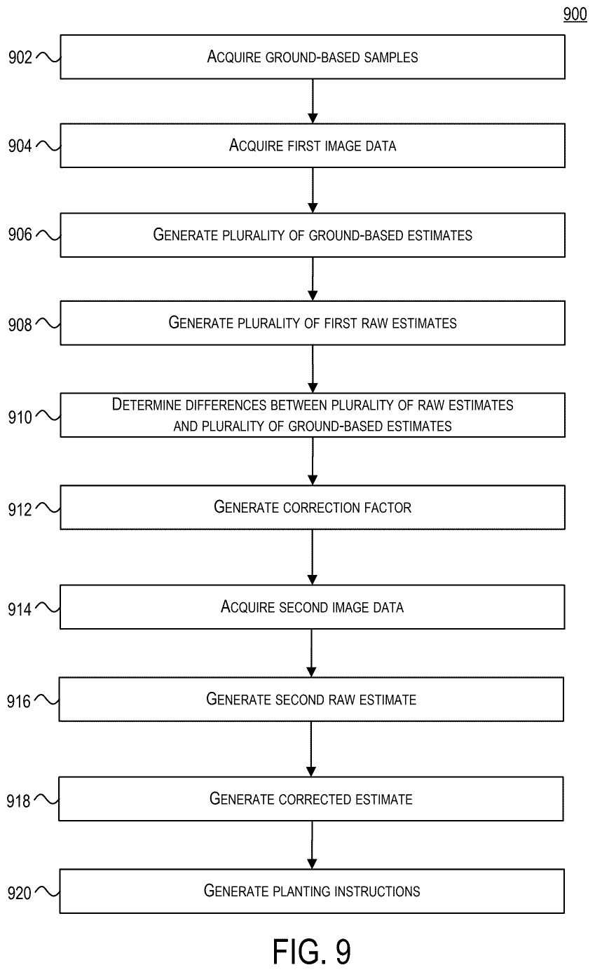

FIG. 9 shows an example flow chart for automated generation of crop development estimates according to one or more aspects of the disclosure. One or more aspects of the disclosure may be implemented by the devices described herein (e.g., the computing system 104 described with respect to FIG. 1). One or more of the steps described with respect to FIG. 9 may be omitted, performed in a different order, and/or modified. Further, one or more additional steps may be added to the steps described with respect to FIG. 9.

At step 902, ground-based samples may be acquired and/or received. The ground-based samples may be associated with at least one trait of a crop variety in a plurality of sample locations. For example, one or more mechanized harvesters (e.g., the harvester device 106 described with respect to FIG. 1) may acquire ground-based samples (e.g., crop samples) from a plurality of locations. The plurality of sample locations and/or the second location (e.g., the second location described in step 914, 918, and 920 with respect to FIG. 9) may be within growing environments that comprise one or more environmental conditions that are within a predetermined range of similarity. The one or more environmental conditions may comprise annual rainfall, average annual temperature, altitude, average annual humidity, available water content and/or soil moisture.

A crop variety may comprise a single genotype of a type of crop. Further, the crop may comprise corn, cotton, canola, soybean, wheat, rice, potatoes, sugar cane, linen, hemp, oats, barley, sorghum, various fruits, various legumes, and/or various vegetables.

At step 904, first image data may be acquired and/or received. The first image data may comprise one or more images associated with a crop variety in a plurality of sample locations. For example, the first image data may comprise one or more images of crops (e.g., crops in a plurality of sample geographic locations) that are captured by an image capture device (e.g., the image capture device 108). Further, the crop variety at the plurality of sample locations may be of the same genotype (e.g., the same genotype of wheat).

At step 906, a plurality of ground-based estimates may be generated. Generation of the plurality of ground-based estimates may be based on ground-based samples of the crop variety in the plurality of sample locations. For example, a plurality of ground-based estimates may be generated based on samples of crops collected by a harvester device (e.g., harvester device 106 described with respect to FIG. 1).

At step 908, a plurality of first raw estimates corresponding to the plurality of sample locations may be generated. Generation of the plurality of first raw estimates may be based on inputting the first image data into one or more machine learning models. The one or more machine-learning models (e.g., the one or more machine learning models 208 described with respect to FIG. 2) may be configured and/or trained to determine and/or generate a plurality of first raw estimates based on input comprising the first image data. The plurality of first raw estimates may comprise values (e.g., a numerical values) that may be associated with at least one crop trait (e.g., yield). For example, the plurality of first raw estimates may comprise a plurality of estimated crop yields for a plurality of sample locations. In some embodiments, the plurality of first raw estimates may be based on processing the first image data. For example, the first image data may be used as input to a raw estimate algorithm that performs operations on the input and outputs the plurality of raw estimates. By way of further example, for a cotton crop variety the plurality of first raw estimates and/or the plurality of ground-based estimates may comprise lint yields of a single genotype of cotton and/or a boll compactness of the single genotype of cotton. Further, for a corn crop the plurality of first raw estimates and/or the plurality of ground-based estimates may comprise a number of bushels per acre of the single genotype of corn.

At step 910, determining, for each of the plurality of sample locations, differences between the plurality of first raw estimates and the plurality of ground-based estimates. For example, a computing system (e.g., computing system 104 described with respect to FIG. 1) may compare the plurality of first raw estimates to the plurality of ground-based estimates at each of the plurality of locations. The computing system may then determine the differences at each of the plurality of locations.

At step 912, a correction factor may be determined and/or generated. Determination and/or generation of the correction factor may be based on a predictive analysis (e.g., linear regression analysis, nonlinear regression analysis, and/or machine learning model based analysis) of the plurality of first raw estimates and the plurality of ground-based estimates. Predictive analysis may comprise using one or more predictive techniques to determine and/or generate a correction factor that may be applied to a raw estimate in order to generate a corrected estimate that is more similar to a ground-based estimate associated with the same location as the raw estimate. Further, the correction factor may be associated with minimization of the differences between the plurality of first raw estimates and the plurality of ground-based estimates in each of the plurality of sample locations. For example, a computing system (e.g., computing system 104 described with respect to FIG. 1) may determine and/or generate a correction factor by implementing predictive analysis (e.g., linear regression analysis, nonlinear regression analysis, or machine learning model based analysis) as described with respect to FIGS. 3-7. Further, linear regression analysis may comprise determining a mean raw estimate based on the plurality of first raw estimates of the plurality of sample locations. Further, linear regression analysis may be based on using at least a predetermined number of the plurality of first raw estimates that are greater than the mean raw estimate and a predetermined number of the plurality of first raw estimates that are less than the mean raw estimate. For example, a computing system (e.g., computing system 104 described with respect to FIG. 1) may determine a mean raw yield estimate for the plurality of sample locations. A predetermined number or proportion of the estimated yields may be used in the linear regression analysis.

In some embodiments, determination and/or generation of the correction factor may be based on a nonlinear regression analysis of the plurality of first raw estimates and the plurality of ground-based estimates. Additionally, in some embodiments, genetic information may be used in the linear regression analysis for the correction factor. In some embodiments, the estimation of the adjustment factor for a particular genotype may employ data obtained from genetic relatives of a crop variety having a single genotype, in addition to data obtained from the crop variety itself. In some embodiments, an adjustment factor can be generated for crop variety genotypes for which no ground data was obtained by using the information of genetic relatives for which data was obtained.

In some embodiments, determination and/or generation of a correction factor may be based on use of one or more machine learning models. The one or more machine learning models may be configured and/or trained to analyze the plurality of first raw estimates and/or the plurality of ground-based estimates to determine and/or generate a correction factor. For example, the one or more machine learning models may be configured and/or trained to receive input comprising the plurality of first raw estimates and the plurality of ground-based estimates; perform operations on the plurality of first raw estimates and the plurality of ground-based estimates; and generate output comprising the correction factor.

At step 914, second image data may be acquired and/or received. The second image data may comprise images of a crop in a second location that is not included in the plurality of sample locations. The crop may be of the same crop variety (e.g., the same genotype) as the crop variety of the first image data. For example, the second image data may comprise one or more images of crops (e.g., crops in a plurality of sample geographic locations) that are captured by an image capture device (e.g., the image capture device 108). Further, the crop variety at the crops at the second location may be of the same genotype (e.g., the same genotype of wheat).

At step 916, a second raw estimate may be generated. The second raw estimate may be generated based on inputting the second image data into one or more machine learning models. The one or more machine-learning models (e.g., the one or more machine learning models 208 described with respect to FIG. 2) may be configured and/or trained to determine and/or generate a second raw estimate based on input comprising the second image data. The second raw estimate may comprise values (e.g., a numerical values) that may be associated with at least one crop trait (e.g., yield). For example, the second raw estimate may comprise a plurality of estimated crop yields for a plurality of sample locations. In some embodiments, the second raw estimate may be based on processing the second image data. For example, the second image data may be used as input to a raw estimate algorithm that performs operations on the input and outputs the plurality of raw estimates.

At step 918, a corrected estimate for the crop variety in the second location may be generated. The corrected estimate may be based on fitting a correction factor to the second raw estimate. For example, a computing system (e.g., computing system 104 described with respect to FIG. 1) may fit a correction factor to a second raw estimate by implementing correction factor fitting as described with respect to FIGS. 3-7.

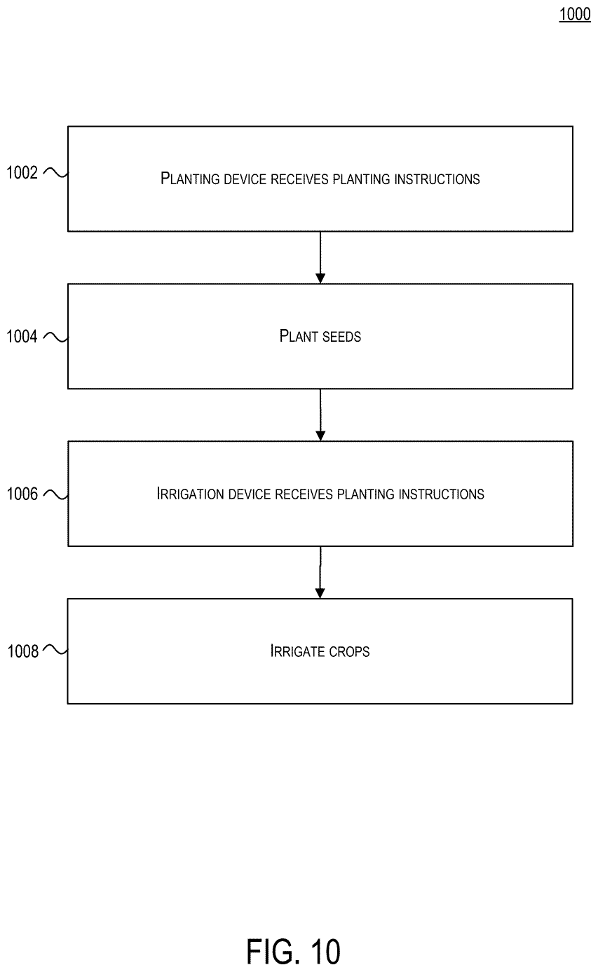

At step 920, planting instructions may be generated. The planting instructions may be based on the corrected estimate. The planting instructions may comprise instructions associated with a distribution of a crop that is planted at locations comprising the plurality of sample locations and/or the second location. For example, a corrected estimate associated with the yield of a wheat crop may be used to determine how many seeds should be planted and/or locations that may result in greater yield at which crops should be planted and/or locations that may result in a lower yield at which planting may be avoided. The planting instructions may comprise a type (e.g., variety of crop) and/or amount of seeds that may be planted at a location at one or more times (e.g., one or more hours of the day and/or one or more days of the year). For example, a planting device (e.g., planting device 110 described with respect to FIG. 1) may plant wheat seeds at a particular location (e.g., the second location) at a date (e.g., February 5^{th}) and/or time (10:23 p.m.) indicated in the planting instructions. The planting instructions may be sent to a planting device and used by the planting device as described in step 1002 with respect to FIG. 10.

Further, the planting instructions may comprise instructions to irrigate a crop using quantities of water, fungicide, and/or pesticide indicated in the planting instructions. The planting instructions may comprise an indication of one or more times at which to irrigate the crop. For example, an irrigation system (e.g., irrigation device 112 described with respect to FIG. 1) may irrigate a crop (e.g., wheat) at a particular location (e.g., the second location) at a date and time indicated in the planting instructions. The planting instructions may be sent to an irrigation device or irrigation system and used by the irrigation device or irrigation system as described in step 1006 with respect to FIG. 10.

In some embodiments, the planting instructions may be generated then accessed by a remote device and/or system that uses the planting instructions. The remote device may implement the planting instructions via one or more devices associated with the planting and/or irrigation of a crop. Further, the planting instructions may be used as a recommendation to determine a type and/or an amount of seeds to plant and/or an amount of water, fungicide, and/or pesticide to apply to crops.

FIG. 10 shows an example flow chart for implementing planting instructions according to one or more aspects of the disclosure. One or more aspects of the disclosure may be implemented by the devices described herein (e.g., the computing system 10 described with respect to FIG. 1). One or more of the steps described with respect to FIG. 10 may be omitted, performed in a different order, and/or modified. Further, one or more additional steps may be added to the steps described with respect to FIG. 10.

At step 1002, planting instructions may be received by a planting device. A planting device (e.g., the planting device 110 described with respect to FIG. 1) may comprise a wireless receiver that is configured to receive signals comprising planting instructions. For example, a mechanical cotton planter may receive planting instructions to plant specified amounts of cotton seeds.

At step 1004, seeds may be planted in the second location. Planting of the seeds may be based on the planting instructions. For example, based on received planting instructions, a mechanical cotton planter may plant a specific amount of cotton seeds at a specified location (e.g., the second location described in steps 914, 918, and 920 with respect to FIG. 9).

At step 1006, planting instructions may be received by an irrigation device or irrigation system. An irrigation device (e.g., the irrigation device 112 described with respect to FIG. 1) may comprise a wireless receiver that is configured to receive signals comprising planting instructions. For example, a cotton irrigation device may receive planting instructions comprising an amount of water, fertilizer, and/or pesticide to apply to crops at one or more times.

At step 1008, a crop in the second location may be irrigated based on the planting instructions. For example, an irrigation device may irrigate a crop in a second location using quantities of water based on the planting instructions. For example, based on received planting instructions, an irrigation device may apply a specific amount of water to a cotton crop at a specified location (e.g., the second location described in steps 914, 918, and 920 with respect to FIG. 9).

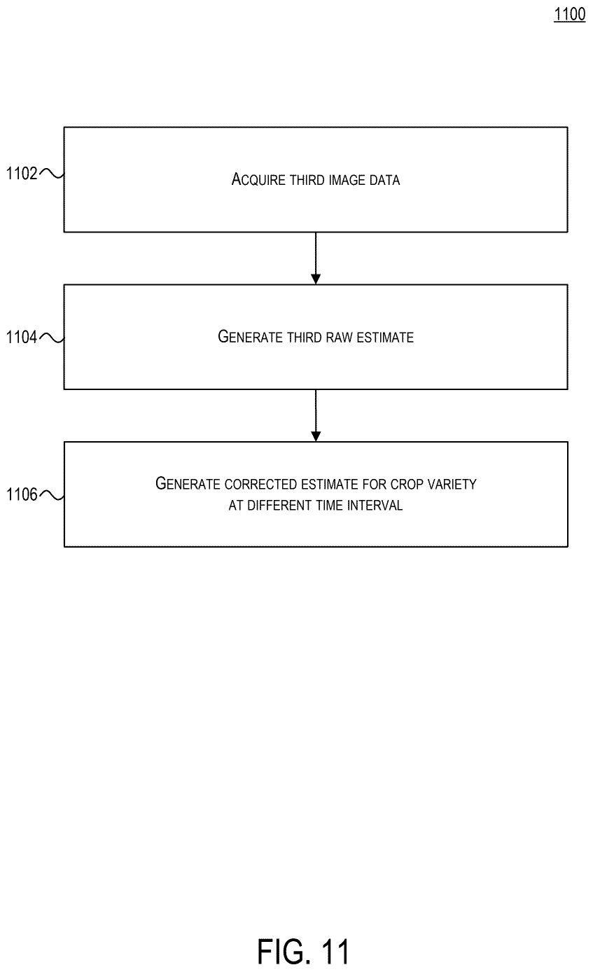

FIG. 11 shows an example flow chart for generating corrected crop development estimates according to one or more aspects of the disclosure. One or more aspects of the disclosure may be implemented by the devices described herein (e.g., the computing system 104 described with respect to FIG. 1). One or more of the steps described with respect to FIG. 11 may be omitted, performed in a different order, and/or modified. Further, one or more additional steps may be added to the steps described with respect to FIG. 11.

At step 1102, third image data may be acquired. The third image data may comprise a second set of images of a crop variety in one of a plurality of sample locations. The second set of images may comprise images captured at a different time interval from a time interval at which the images of the crop variety in the plurality of sample locations were captured. For example, the second set of images may comprise one or more images of crops at a sample location that were captured at different time of the year (e.g., images captured during the summer and images captured during the winter) and/or images captured at different times of day (e.g., images captured in the morning and/or images captured in the afternoon or early evening). Further, the third image data may comprise one or more images of crops (e.g., crops in a plurality of sample locations described in steps 902-920 with respect to FIG. 9) that are captured by an image capture device (e.g., the image capture device 108). Further, the crop variety at the crops at the third location may be of the same genotype (e.g., the same genotype of wheat).

At step 1104, a third raw estimate may be generated. Generation of the third raw estimate may be based on inputting the third image data into the one or more machine learning models. The one or more machine-learning models (e.g., the one or more machine learning models 208 described with respect to FIG. 2) may be configured and/or trained to determine and/or generate a third raw estimate based on input comprising the third image data. The third raw estimate may comprise values that may be associated with at least one crop trait (e.g., yield). For example, the third raw estimate may comprise a plurality of estimated crop yields for a plurality of sample locations (e.g., the plurality of sample locations described in steps 902-920 with respect to FIG. 9). In some embodiments, the third raw estimate may be based on processing the third image data. For example, the third image data may be used as input to a raw estimate algorithm that performs operations on the input and outputs the third raw estimate.

At step 1106, a corrected estimate for the crop variety at the different time interval may be generated. The corrected estimate may be based on fitting the correction factor to the third raw yield estimate. The corrected estimate may be based on fitting a correction factor to the third raw estimate. For example, a computing system (e.g., computing system 104 described with respect to FIG. 1) may fit a correction factor to a second raw estimate by implementing a correction factor fitting as described with respect to FIGS. 3-7.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The steps of the methods described herein are described as being performed in a particular order for the purposes of discussion. A person having ordinary skill in the art will understand that the steps of any methods discussed herein may be performed in any order and that any of the steps may be omitted, combined, and/or expanded without deviating from the scope of the present disclosure. Furthermore, the methods described herein may be performed using any manner of device, system, and/or apparatus including the computing devices, computing systems, and/or computing apparatuses that are described herein.

What is claimed is:

1. A mechanized system for improving yield of a cotton crop, the system comprising:
a mechanized cotton harvester configured to extract seed cotton from cotton bolls of a cotton crop variety in a plurality of sample locations, wherein the cotton crop variety is of a single genotype;
a cotton gin configured to:
separate cotton lint from the seed cotton in the plurality of sample locations; and
gather ground-based lint samples of the cotton crop variety based on the cotton lint extracted in the plurality of sample locations;
an aerial device comprising an image capture device configured to:
acquire first image data comprising images of the cotton crop variety in the plurality of sample locations; and
acquire second image data comprising images of the cotton crop variety in a second location that is not included in the plurality of sample locations;
a computing device configured to:
generate, based on the second image data, an image-based yield estimate for the cotton crop variety in the second location;
generate, based on fitting a correction factor to the image-based yield estimate, a corrected yield estimate for the cotton crop variety of the single genotype at the second location; and
generate, based on the image-based yield estimate, cotton planting instructions associated with cultivation of the cotton crop variety; and
a mechanical cotton planter configured to:
receive the cotton planting instructions; and
plant seeds in the second location based on the cotton planting instructions.

2. The system of claim 1, wherein the system further comprises:
a sprinkler irrigation system configured to:
receive the cotton planting instructions; and
irrigate the cotton crop variety in the second location using quantities of water based on the cotton planting instructions.

3. The system of claim 1, wherein the cotton planting instructions comprise instructions associated with a distribution of the cotton crop variety that is planted at locations comprising the plurality of sample locations and the second location.

4. The system of claim 1, wherein the computing device comprises one or more processors and a memory storing instructions that, when executed by the one or more processors, cause the computing device to generate the corrected yield estimate for the cotton crop variety of the single genotype at the second location by performing operations comprising:
determining, based on analysis of the ground-based lint samples of the cotton crop variety, a plurality of ground-based yield estimates;
determining, based on inputting the first image data into one or more machine learning models, a plurality of image-based yield estimates corresponding to the plurality of sample locations;
determining, for each of the plurality of sample locations, differences between the plurality of image-based yield estimates and the plurality of ground-based yield estimates; and
determining, based on a predictive analytic model of the plurality of image-based yield estimates and the plurality of ground-based yield estimates, the correction factor, wherein the predictive analytic model comprises minimization of differences between the plurality of image-based yield estimates and the plurality of ground-based yield estimates in each of the plurality of sample locations.

5. A method of generating a crop development estimate for a crop variety, the method comprising:
acquiring, by a mechanized harvester, ground-based samples associated with at least one trait of the crop variety in a plurality of sample locations;
acquiring, by an image capture device, first image data comprising images associated with the at least one trait of the crop variety in the plurality of sample locations;
generating, by a computing device comprising one or more processors, based on the ground-based samples of the crop variety, a plurality of ground-based estimates associated with the at least one trait of the crop variety in the plurality of sample locations;
generating, by the computing device, based on inputting the first image data into one or more machine learning models, a plurality of first raw estimates corresponding to the plurality of sample locations;
determining, by the computing device, for each of the plurality of sample locations, differences between the plurality of first raw estimates and the plurality of ground-based estimates;
determining, by the computing device, based on predictive analysis of the plurality of first raw estimates and the plurality of ground-based estimates, a correction factor associated with minimization of the differences between the plurality of first raw estimates and the plurality of ground-based estimates in each of the plurality of sample locations;
acquiring, by the image capture device, second image data comprising images of the crop variety in a second location that is not included in the plurality of sample locations;
generating, by the computing device, based on inputting the second image data into the one or more machine learning models, a second raw estimate; and
generating, by the computing device, based on fitting the correction factor to the second raw estimate, a corrected estimate for the crop variety in the second location.

6. The method of claim 5, wherein the crop variety comprises a single genotype of cotton, and wherein the plurality of first raw estimates and the plurality of ground-based estimates comprise lint yields of the single genotype of cotton or boll compactness of the single genotype of cotton.

7. The method of claim 5, wherein the plurality of sample locations and the second location are within growing environments that comprise one or more environmental conditions that are within a predetermined range of similarity, and wherein the one or more environmental conditions comprise annual rainfall, average annual temperature, or soil moisture.

8. The method of claim 5, wherein the crop variety comprises a single genotype of corn, and wherein the plurality of first raw estimates and the plurality of ground-based estimates comprise a number of bushels per acre of the single genotype of corn.

9. The method of claim 5, wherein the image capture device comprises an aircraft comprising an aerial drone, and wherein the image capture device is configured to generate the first image data by capturing the images from above the plurality of sample locations.

10. The method of claim 5, further comprising:
acquiring, by the image capture device, third image data comprising a second set of images of the crop variety in one of the plurality of sample locations, wherein the second set of images is captured at a different time interval from a time interval at which the images of the crop variety in the plurality of sample locations are captured;
generating, by the computing device, based on inputting the third image data into the one or more machine learning models, a third raw estimate; and
generating, by the computing device, based on fitting the correction factor to the third raw estimate, a corrected estimate for the crop variety at the different time interval.

11. The method of claim 5, wherein the predictive analysis employs a predictive analytic model that comprises a linear regression analysis, and wherein the plurality of sample locations and the crop variety are independent variables in the linear regression analysis, and wherein the plurality of first raw estimates are dependent variables in the linear regression analysis.

12. The method of claim 5, further comprising:
determining, by the computing device, a mean raw estimate based on the plurality of first raw estimates of the plurality of sample locations; and
determining, by the computing device, that the predictive analysis is based on at least a first predetermined number of the plurality of first raw estimates that are greater than the mean raw estimate and a second predetermined number of the plurality of first raw estimates that are less than the mean raw estimate.

13. The method of claim 5, wherein the one or more machine learning models comprise a first machine learning model configured to extract one or more features from the images of the crop variety in the plurality of sample locations.

14. The method of claim 13, wherein the one or more machine learning models comprise a second machine learning model configured to generate the plurality of first raw estimates based on the one or more features extracted by the first machine learning model, wherein the one or more machine learning models comprise a convolutional neural network, and wherein the one or more features comprise crop cover or crop area.

15. The method of claim 5, wherein the at least one trait of the crop variety comprises a yield trait, a phenological trait, an agronomic trait, a plant quality trait, a biotic stress trait, or an abiotic stress trait.

16. The method of claim 5, wherein the images of the crop variety in the plurality of sample locations and the images of the crop variety in the second location are captured within a same time interval.

17. The method of claim 5, wherein the plurality of sample locations and the second location are within a predetermined geographic area.

18. The method of claim 5, wherein the predictive analysis comprises linear regression analysis, nonlinear regression analysis, or a machine learning model based analysis.

19. One or more non-transitory computer readable media comprising instructions that, when executed by at least one processor, cause a computing device to perform operations comprising:
receiving ground-based samples associated with at least one trait of a crop variety in a plurality of sample locations that were acquired by a mechanized harvester;
receiving first image data acquired by an image capture device, wherein the first image data comprises images associated with the at least one trait of the crop variety in the plurality of sample locations;
generating, based on the ground-based samples associated with at the least one trait of the crop variety, a plurality of ground-based estimates associated with the at least one trait of the crop variety in the plurality of sample locations;
generating, based on inputting the first image data into one or more machine learning models, a plurality of first raw estimates corresponding to the plurality of sample locations;
determining, for each of the plurality of sample locations, differences between the plurality of first raw estimates and the plurality of ground-based estimates;
determining, based on a predictive analysis of the plurality of first raw estimates and the plurality of ground-based estimates, a correction factor associated with minimization of differences between the plurality of first raw estimates and the plurality of ground-based estimates in each of the plurality of sample locations;
receiving, from the image capture device, second image data comprising images of the crop variety in a second location that is not included in the plurality of sample locations;
generating, based on inputting the second image data into the one or more machine learning models, a second raw estimate; and
generating, based on fitting the correction factor to the second raw estimate, a corrected estimate for the crop variety in the second location.

20. The one or more non-transitory computer readable media of claim 19, wherein the predictive analysis comprises linear regression analysis, nonlinear regression analysis, or machine learning model based analysis.
